(19) United States
(12) Patent Application Publication
(10) Pub. No.: US 2002/0091700 A1
(43) Pub. Date: Jul. 11, 2002

(54) Unique architecture for handheld computers

(76) Inventors: Robert A. Steele, Arlington, VA (US); Deanna R. Davidson, Bristow, VA (US); Jason N. Davidson, Bristow, VA (US); Raj Banga, Reston, VA (US); John Lamb, Yardley, PA (US); Roger A. Young, Reston, VA (US); David L. Neyland, Reston, VA (US)

Correspondence Address: GREENBERG-TRAURIG, 1750 TYSONS BOULEVARD, 12TH FLOOR, MCLEAN, VA, 22102, US

(21) Appl. No.: 09/764,205

(22) Filed: Jan. 19, 2001

Related U.S. Application Data
(60) Provisional application No. 60/177,219, filed on Jan. 21, 2000.
(60) Provisional application No. 60/177,220, filed on Jan. 21, 2000.

(51) Int. Cl. G06F 17/00

(52) U.S. Cl. 707/100

(57) ABSTRACT

A unique database architecture and applications for enabling large amounts of text and graphic images to be displayed on handheld computing devices such as personal digital assistants, smart phones, and other wireless personal computer platforms is disclosed. The unique database architecture and applications provide a user friendly interface for creating and storing text and graphic or image content using a standard personal computer in which the data is converted, compressed, manipulated and stored into the unique database architecture. The converted and compressed data can be loaded onto a handheld computing device to provide a tool for viewing the text and image content in a small portable form. The unique database architecture and applications are particularly useful for providing mobile content such as reference materials, training materials, question and answer information, entertainment content, and other content based resources.

### PRIORITY CLAIM

The present invention claims priorities from U.S. Provisional Patent Application Nos. 60/177,219 and 60/177,220, filed Jan. 21, 2000, the contents of which, including all Appendices and Figures, are incorporated herein by reference.

### FIELD OF THE INVENTION

The present invention relates to handheld computers, and more particularly to a unique database architecture which enables text and graphic data to be displayed on handheld computer devices.

### BACKGROUND OF THE INVENTION

Handheld computers and personal digital assistants (PDAs) are small mobile hand held devices which provide computing and information storage and retrieval capabilities for both personal and business use. These handheld computer devices are often used for keeping schedule calendars, address book information, as well as management of email, personal notes and expenses. The handheld computer devices or PDAs are often referred to by the popular name brand PDA products such as the “Palm Pilot” by 3Com or “Palm Top” by Hewlett Packard.

Most handheld computers have a small keyboard or some sort of electronically sensitive pad on which handwriting can be received.

Some handheld computers offer a variation of the Microsoft Windows operating system platform, while the majority use 3Com's Palm OS operating system. Palm OS has always been designed to fit into a palm sized device of a specific size and a specific display size.

Notable limitations of handheld computer devices relate to the relative size of the devices which impose limitations on available memory and screen display size. Therefore, handheld computer devices are limited in their ability to display large text and graphic files which require large memory. Large files are difficult to display in a useful manner on the small screen of these handheld computer devices and are difficult to store on the limited memory of such devices.

Typical handheld computer databases such as the Palm OS database use a set of memory blocks allocated from the overall machine storage heap. The memory blocks are linked together to form a single entity managed by the Palm OS Data Manager. There are two kinds of Palm databases: resource and record. A resource database manages a set of resources (memory blocks tagged with a resource type and ID) and is unordered, except by the type and ID information. A record database manages a set of records (memory blocks tagged with a positional index and unique ID) in which the records are ordered and identified by index. Records also have a unique ID that is used for synchronization purposes.

Some of the inherent problems associated with the PALM OS database type is that the Palm databases are specific to devices using the Palm OS. In addition, the Palm databases do not directly support the required relational structures needed.

Other databases used by handheld computers include traditional relational databases. Two such products using a traditional relational database which have been developed for the PalmOS that implement the full relational database paradigm are Sybase's Ultralite and Oracle's Lite Consolidator. Both of these products support a limited SQL interface mechanism and traditional database capabilities. However, traditional relational databases consume substantial system resources which are extremely limited on handheld computers. In addition, traditional relational databases are designed to take advantage of multi-threaded environments which are not available on handheld computer devices.

Therefore, what is needed is a unique database architecture which conserves power consumption and memory on handheld computers and a system which can display text and image files in a usable format and manner on handheld computer devices such as PDAs, smart phones and other wireless personal computer platforms.

### SUMMARY OF THE INVENTION

The present invention overcomes the limitations of traditional database architecture systems for handheld computers and provides a unique database architecture which helps to minimize handheld computer system resources such as power and memory.

In addition, the present invention provides a system and methods for converting, storing and recovering text and image files into the unique database architecture. The converted text and image content can then be displayed on handheld computing devices such as PDAs, smart phones and other wireless personal computer platforms.

The present invention provides a system which improves the productivity of handheld computers, smart phones and other wireless personal communications platforms.

The present invention creates databases which can be implemented on the Palm OS as a series of records in a record database which also supports the necessary access options. There is no need to update records on the handheld computer when using the unique database of the present invention as that procedure consumes the resources of the low power handheld computer.

The unique database architecture of the present invention can also be used to create software applications that provide content which can be used as corporate asset tools. The software applications allow users to view and read content based text and graphics anywhere and anytime using their handheld computer or PDA device. In addition, these applications allow users to rapidly navigate through large quantities of complex content.

The content data, such as text and image files, formed by the present invention can be sent to other handheld computers or PDAs either by hot-syncing to a host computer, or having the presentation beamed over an IR channel. The beaming of content facilitates immediate communication between multiple users.

The present invention also provides a method and system for providing large amounts of text and image content in a user friendly manner on handheld computers which can be used for training, reference, testing, and other applications where immediate access to large amounts of information in remote locations is desirable.

### DETAILED DESCRIPTION OF THE DRAWINGS

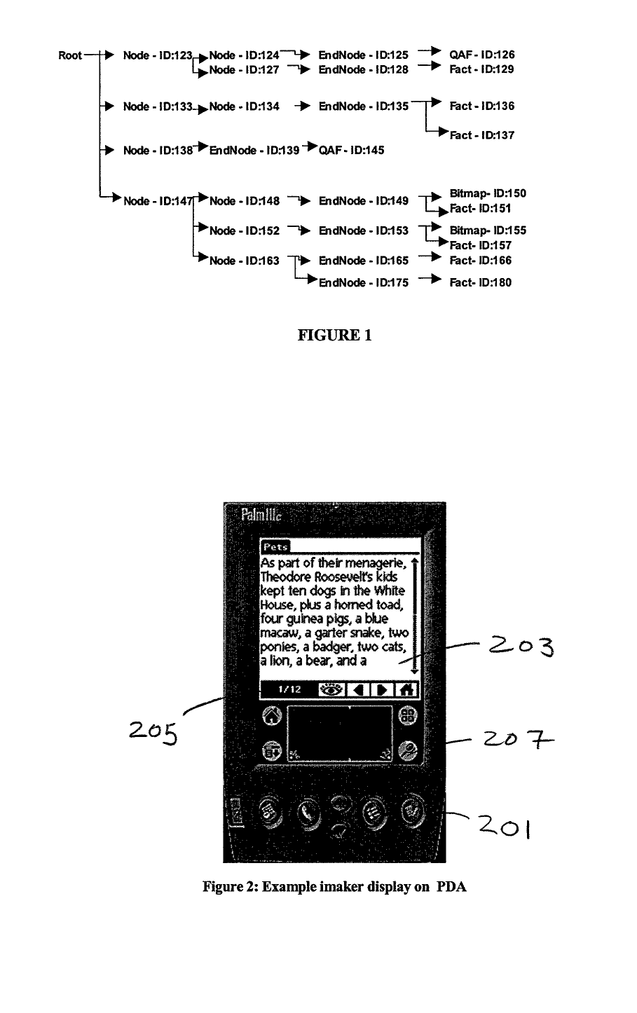

FIG. 1 is an illustrative example of the hierarchical design and location of the data fields of the unique database architecture of the present invention.

FIG. 2 is an illustration of a content based text of a software application of a preferred embodiment displayed on the screen of a handheld computer.

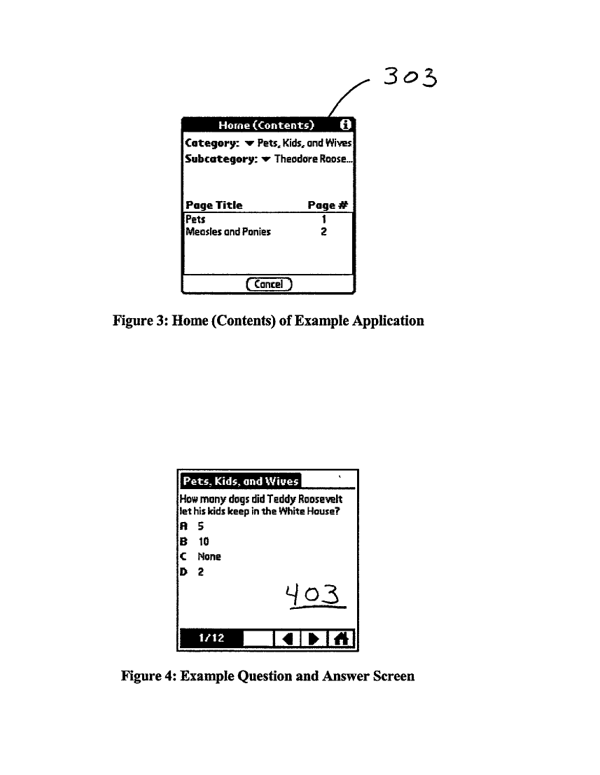

FIG. 3 is a screen capture of a handheld computer user interface of a software application of a preferred embodiment.

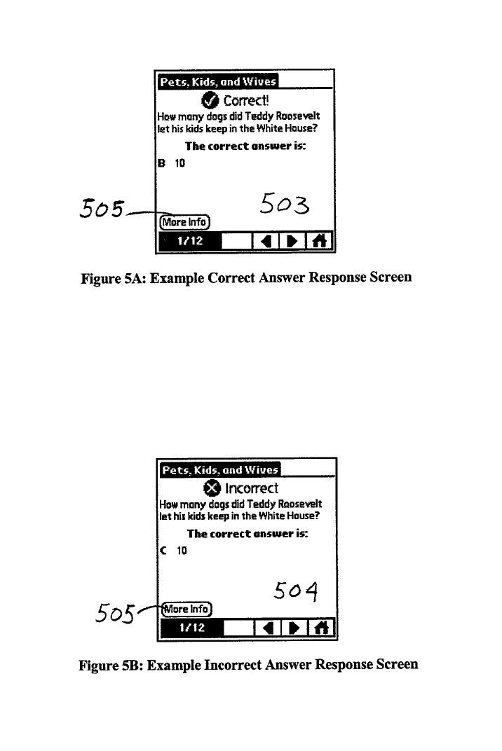

FIG. 4: is a screen capture of a handheld computer user interface displaying a Question and Answer Screen.

FIG. 5A is a screen capture of a handheld computer user interface of a Correct Answer Response Screen.

FIG. 5B is a screen capture of a handheld computer user interface of an Incorrect Answer Response Screen.

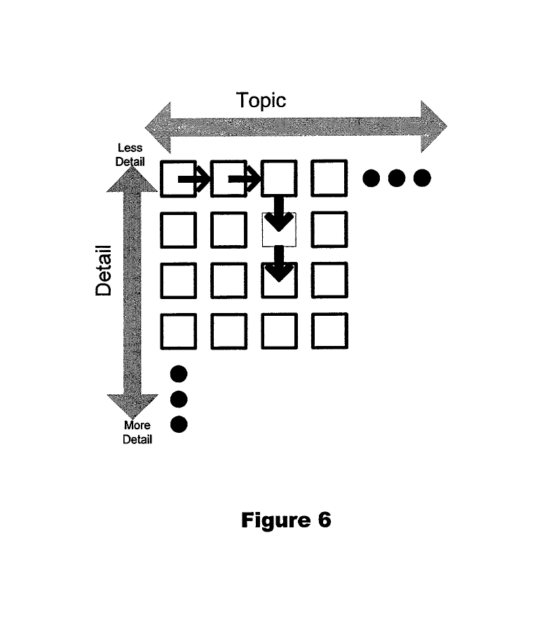

FIG. 6 is an illustration of the conceptual mapping of the user interface with the stored content.

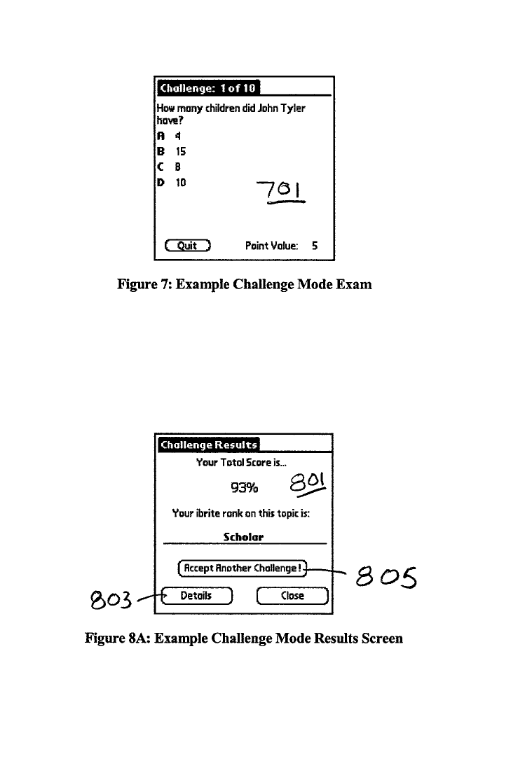

FIG. 7 is a screen capture of a handheld computer user interface of a Challenge Mode Exam.

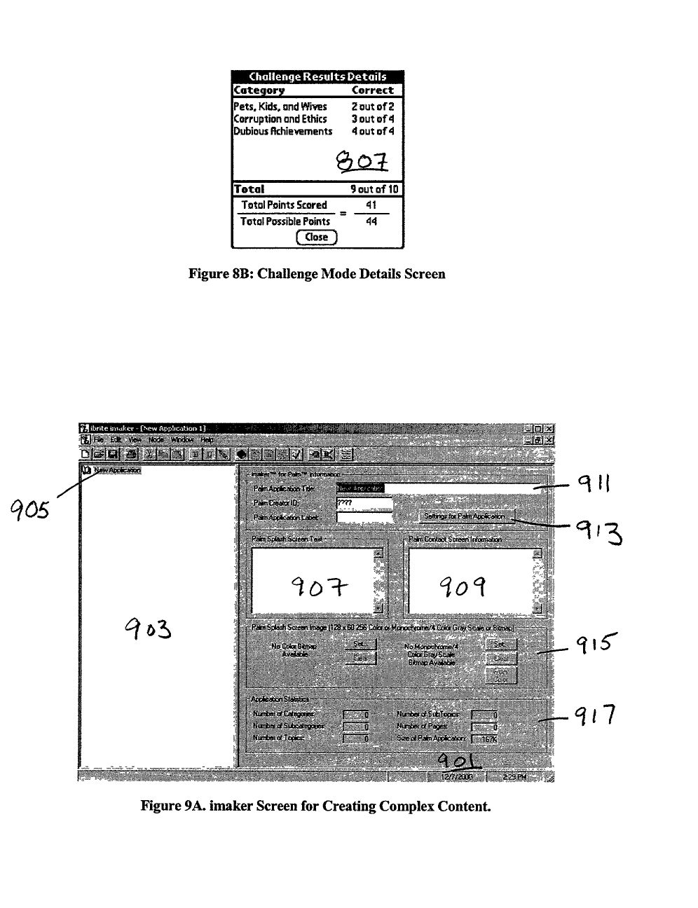

FIG. 8A is a screen capture of a handheld computer user interface of a Challenge Mode Results Screen.

FIG. 8B is a screen capture of a handheld computer user interface of a Challenge Mode Details Screen.

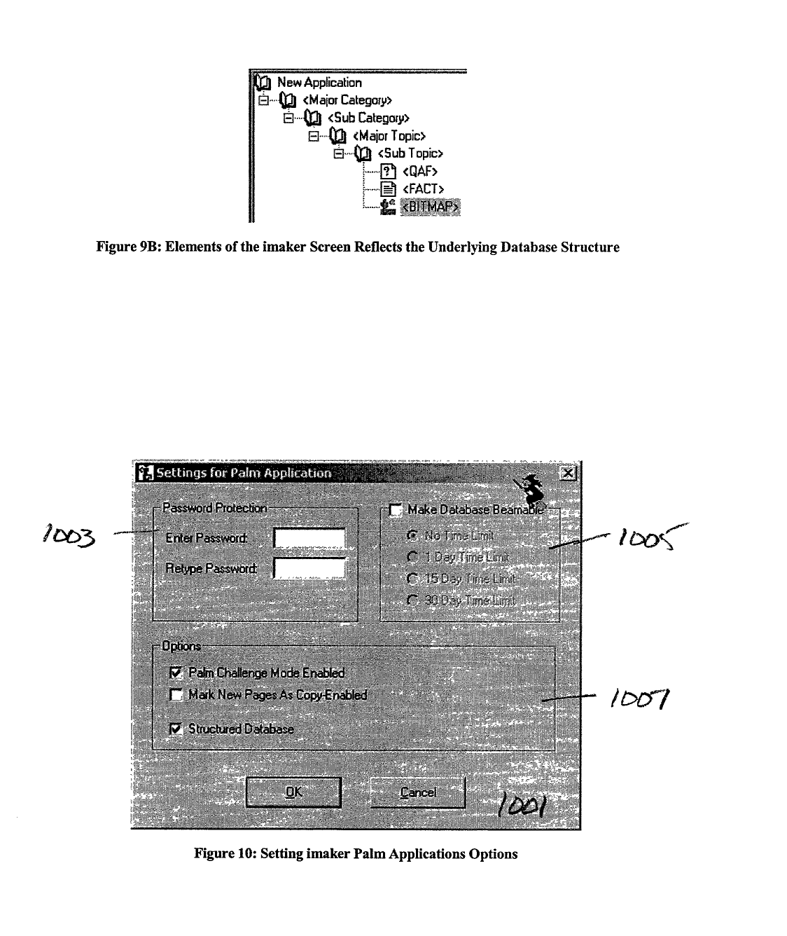

FIG. 9A is a screen capture of the Personal Computer user interface for Creating Complex Content.

FIG. 9B is an illustration reflecting the Underlying Database Structure within the tree navigation window of the user interface.

FIG. 10 is a screen capture of a user interface for setting application options.

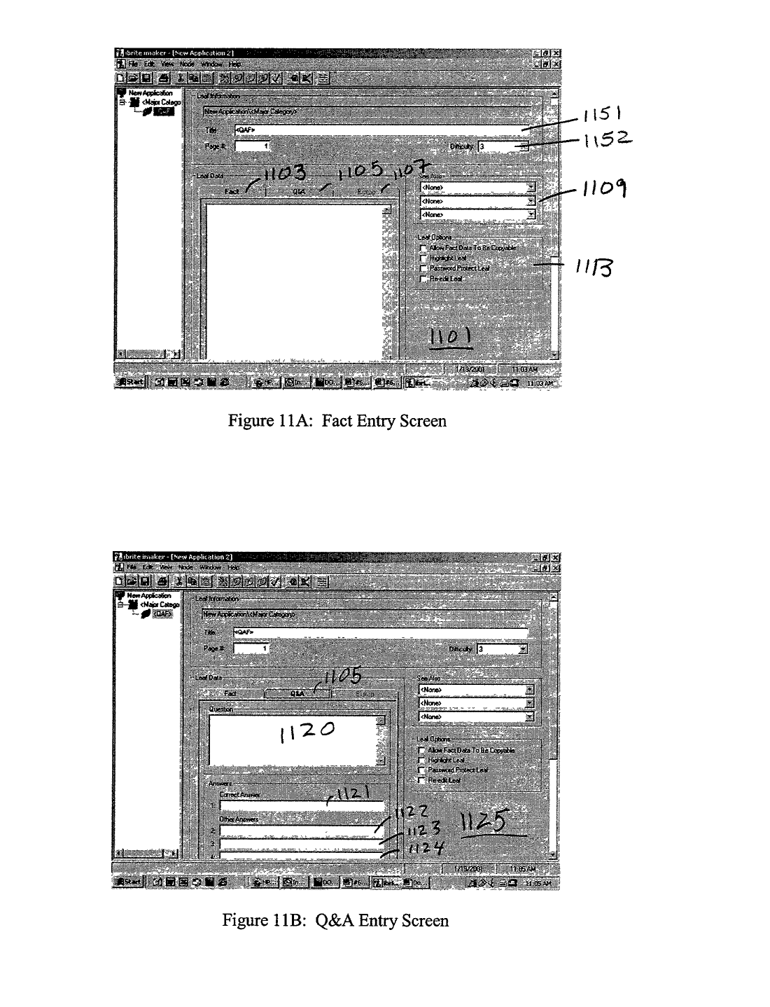

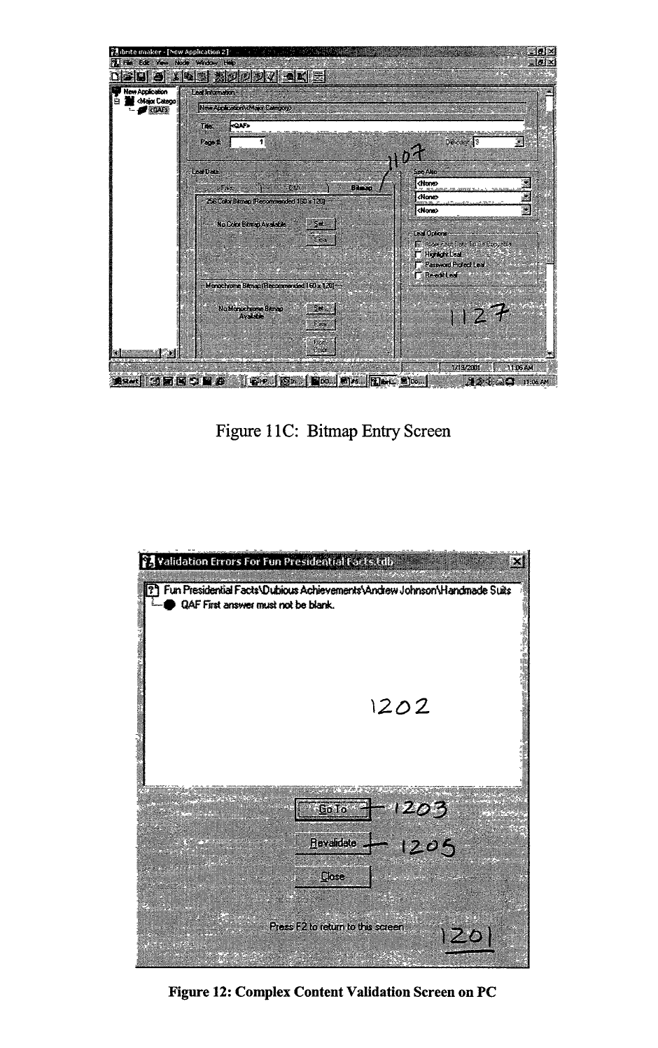

FIG. 11 is a screen capture of a user interface for Fact Entry.

FIG. 12 is a screen capture of a user interface for validation of content.

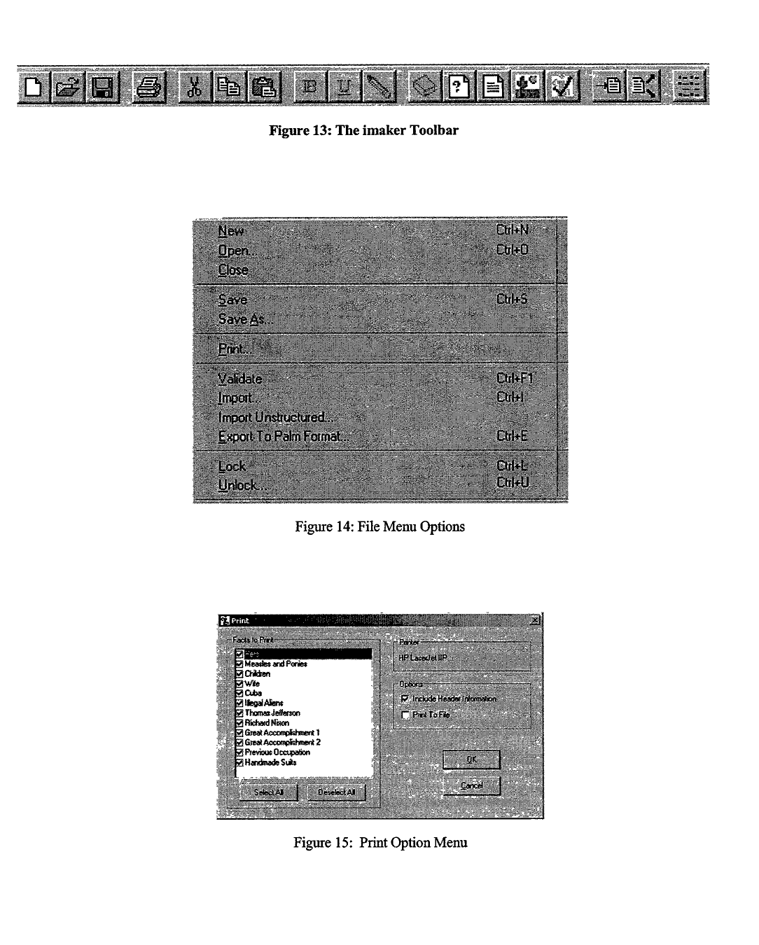

FIG. 13 is an illustration of a toolbar used by a software application of the present invention.

FIG. 14 is an illustration of a File Options Menu.

FIG. 15 is an illustration of a Print Options Menu.

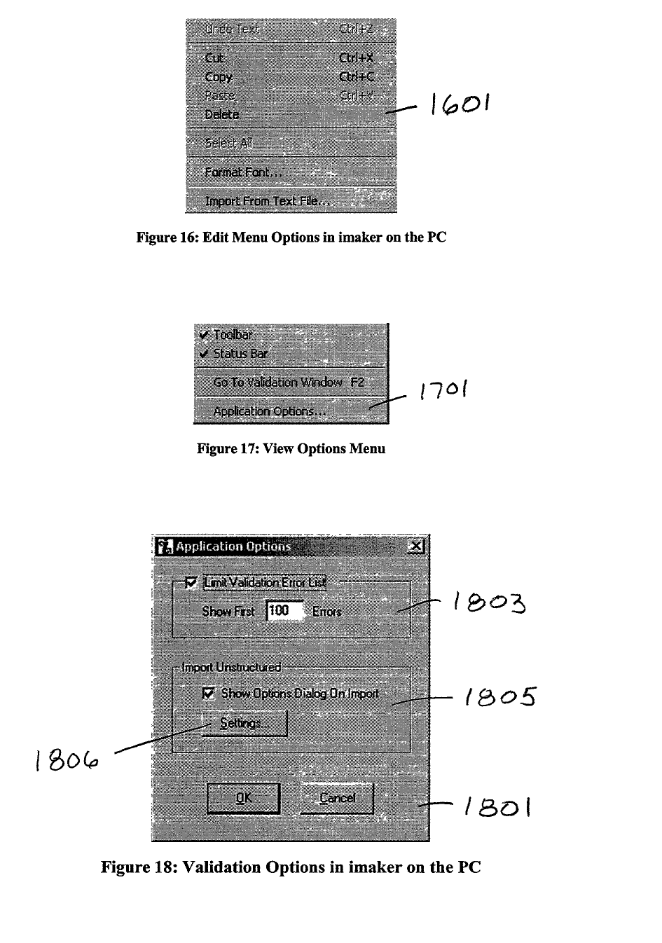

FIG. 16 is an illustration of an Edit Options Menu.

FIG. 17 is an illustration of a View Options Menu.

FIG. 18 is an illustration of an Applications Options dialog box.

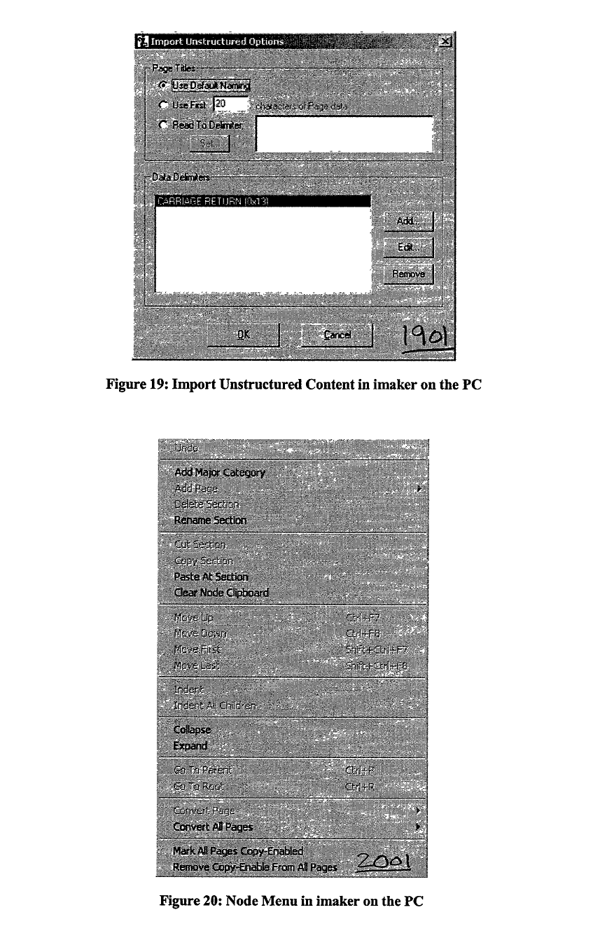

FIG. 19 is an illustration of an Import Unstructured Content dialog box.

FIG. 20 is a an illustration of a Node Menu.

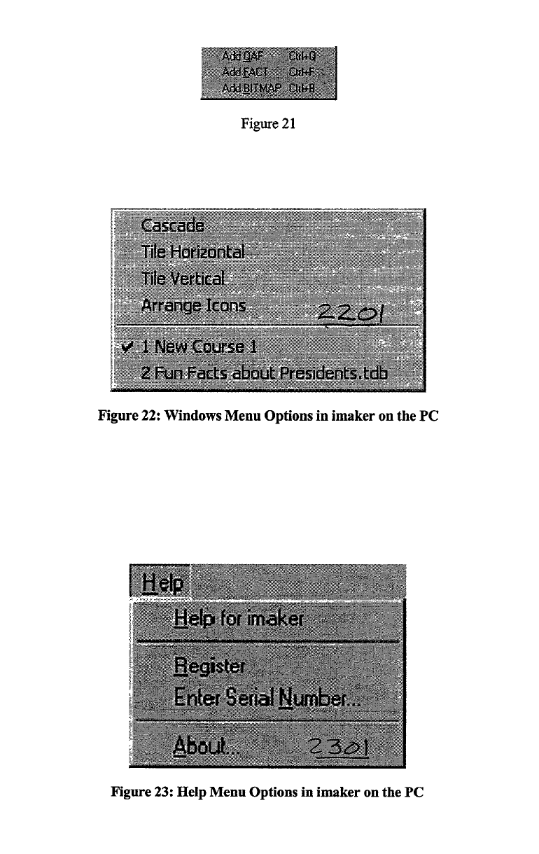

FIG. 21 is an illustration of an Add record menu.

FIG. 22 is an illustration of a Windows Options Menu.

FIG. 23 is an illustration of a Help Options Menu.

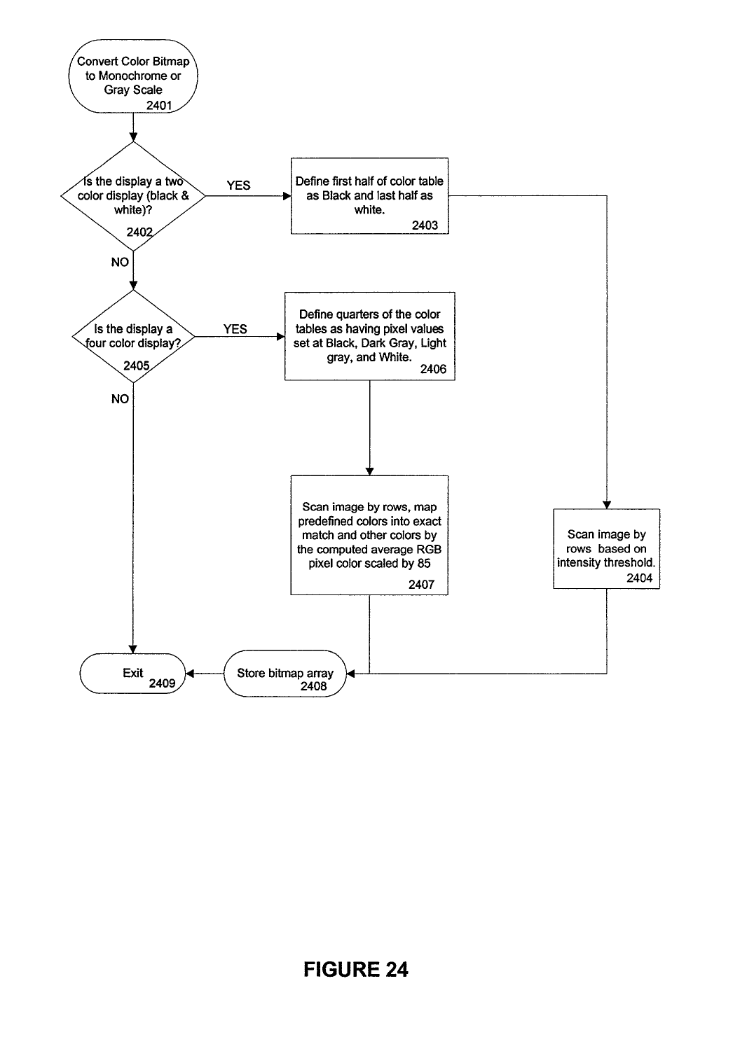

FIG. 24 is a logical flow diagram of the color look-up table modification algorithm.

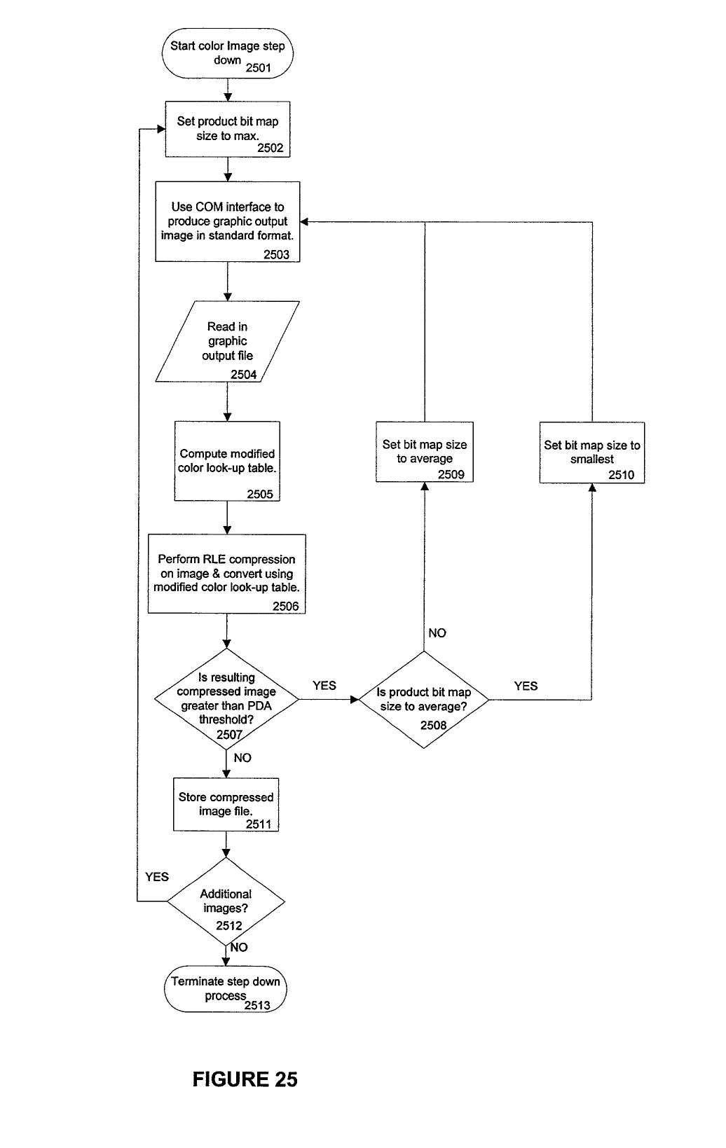

FIG. 25 is a logical flow diagram of the color image step down algorithm.

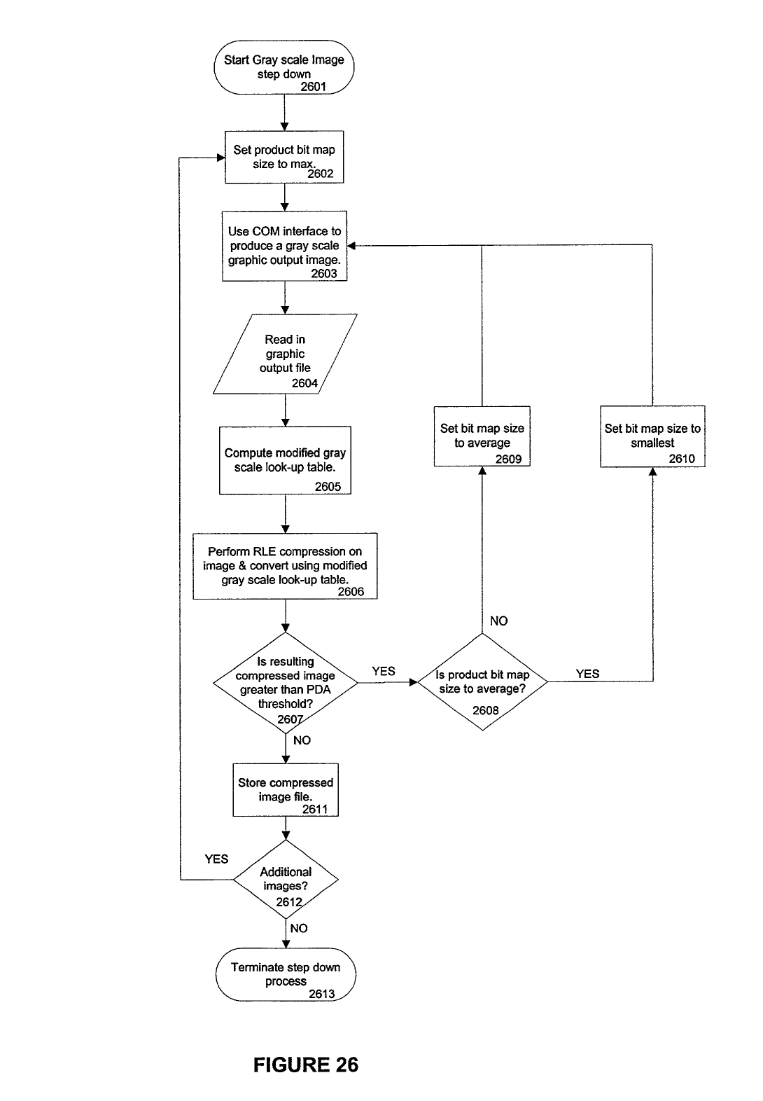

FIG. 26 is a logical flow diagram of the gray scale image step down algorithm.

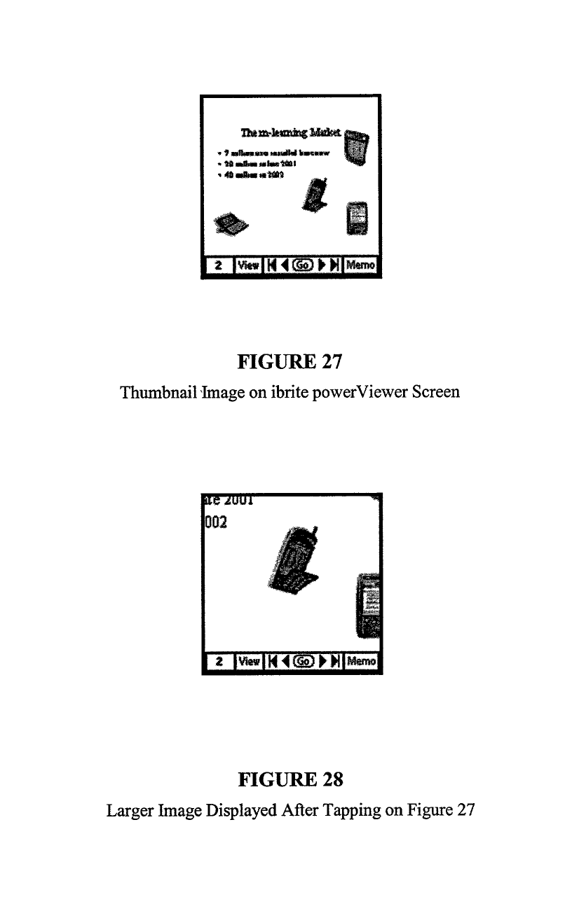

FIG. 27 is a handheld computer screen capture of a graphical image.

FIG. 28 is a handheld computer screen capture of an enlarged image of the image displayed in FIG. 27.

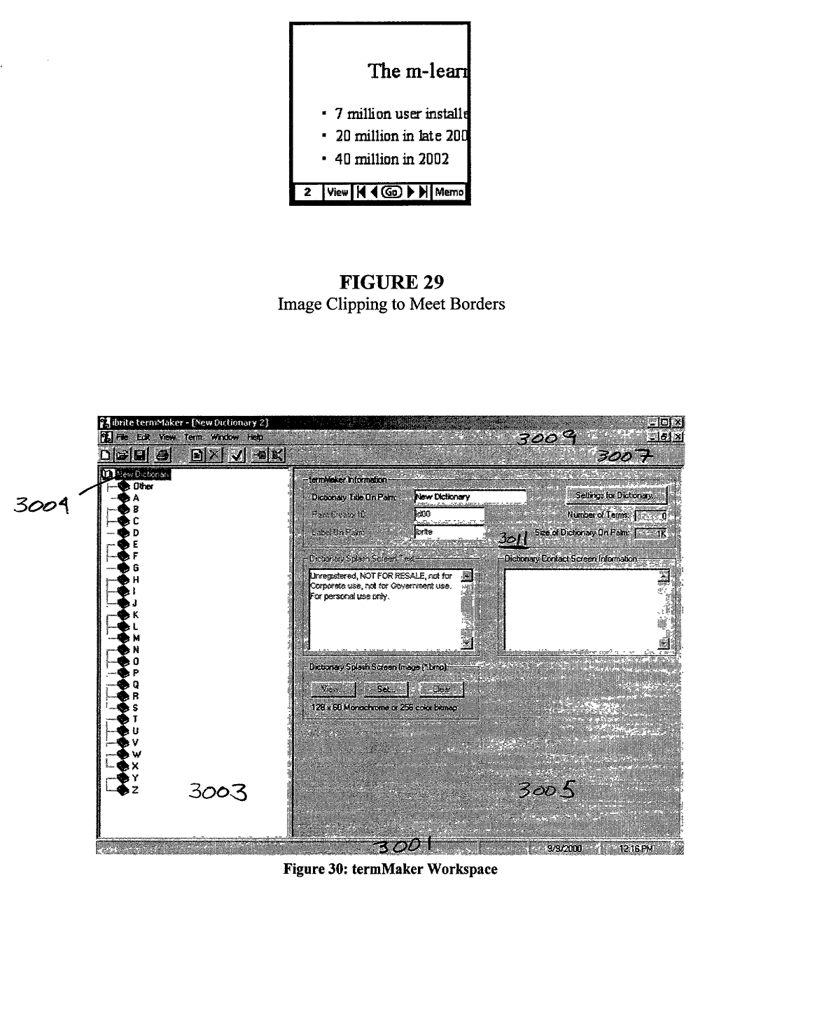

FIG. 29 is a handheld computer screen capture illustrating the image clipping, zoom and scrolling technology of the present invention.

FIG. 30 is a screen capture of a user interface of a software application of another embodiment of the present invention displayed on the screen of a personal computer.

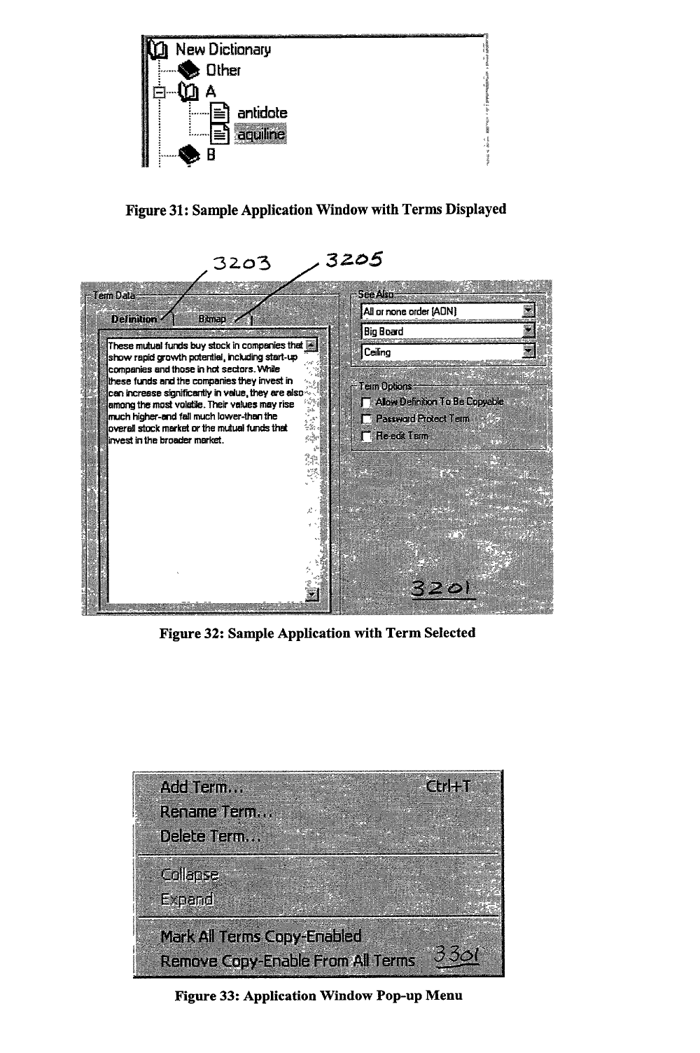

FIG. 31 is an illustration of a application window with terms displayed.

FIG. 32 is a screen capture of a user interface of an application with a term selected.

FIG. 33 is an illustration of an application window pop-up menu.

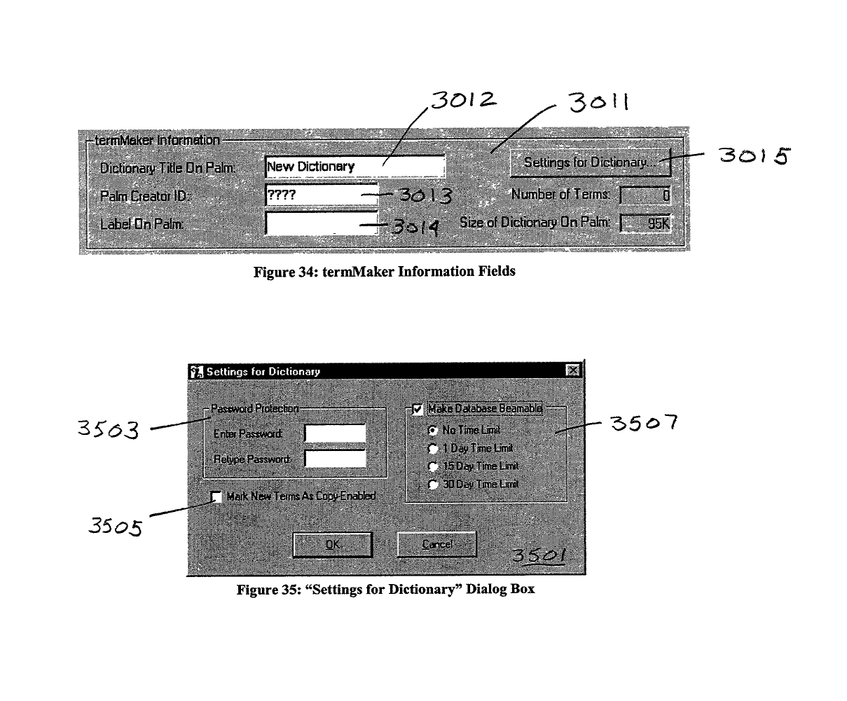

FIG. 34 is a screen capture displaying the user interface of an application information entry fields.

FIG. 35 is a screen capture of a Settings for Dictionary dialog box.

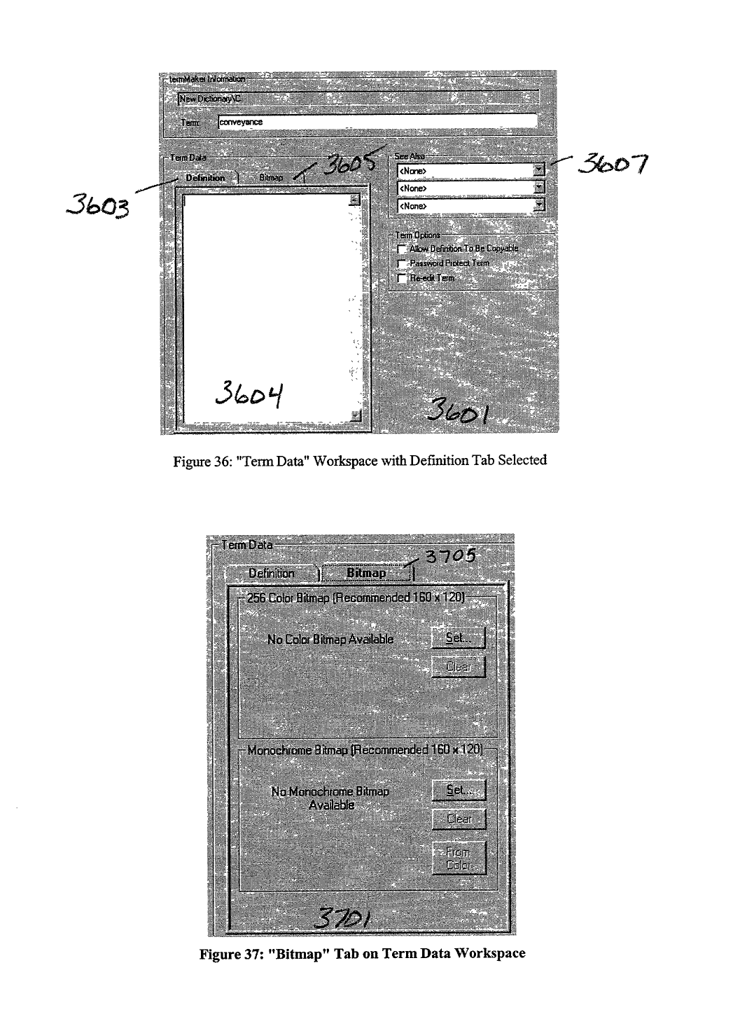

FIG. 36 is a screen capture of a user interface for a Term Data workspace with the Definition tab selected.

FIG. 37 is a screen capture of a user interface for a Term Data workspace with the Bitmap tab selected.

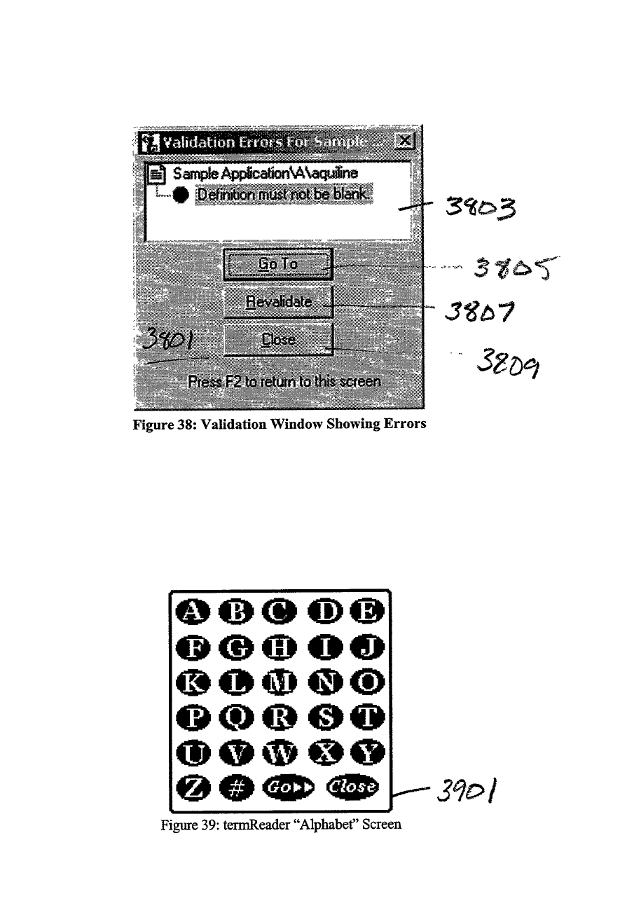

FIG. 38 is screen capture of the Validation Errors Window.

FIG. 39 is a screen capture of a handheld computer Alphabet” Screen.

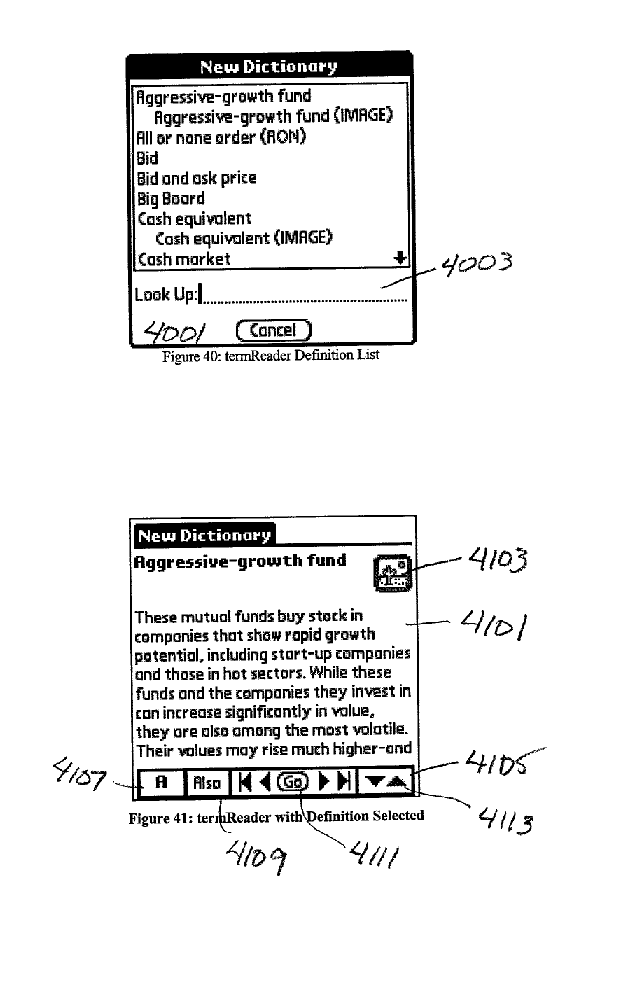

FIG. 40 is a screen capture of a handheld computer of a definition List.

FIG. 41 is a screen capture of a handheld computer of text based content of a selected definition.

### DETAILED DESCRIPTION OF THE INVENTION

The present invention provides a system and methods designed to improve the productivity of handheld computers, smart phones and other wireless personal communications platforms. The system of the present invention includes software applications which convert, store and retrieve text and image data into a unique database structure. The unique database structure allows the storage of text and image data on handheld computers and allows users to access and view the text and images in a usable format.

The unique database structure and other applications and features are described in Provisional Patent Application No. 60/254,131 entitled “System and Methods for Rendering Power Point Displays on a Personal Digital Assistant” which was filed on Dec. 11, 2000, the entire contents of which is incorporated herein by reference.

As will be described in more detail below, the present invention includes software applications, typically run on the content provider host computer, typically a personal computer (PC), which produces the unique database. The unique database is then traversed by a second software application run on a handheld computer. The database architecture is designed to expedite the extraction of complex content with minimum demand on the host computer.

The database has been designed to meet numerous requirements including to store information as a hierarchy of individual nodes where the ending node references one or more leaf. Each leaf contains closely related information and the information can be contained in a variety of formats. The information and formats within a leaf may include: title information in textural format (e.g., the name of a U.S. Government position); fact information in textural format (e.g., the name of a U.S. Government official with brief biography); question and answer information in textural format (e.g., a question specific to that U.S. Government official or position); an illustration (e.g., a bitmap graphic showing the face of the U.S. Government official); and relational keys containing links to other leaf nodes in the database.

The database architecture has also been designed for the ease of building the database on a more powerful machine, and accessing the contents on a lower power machine (e.g., build the database on a Microsoft Windows processor, and display the results in a PalmOS Handheld). In addition, the database architecture is designed so that support software focuses on performance. The support software service routines focus on traversing the contents of the database and retrieving specific record contents. The support software focuses on performance and therefore may not support all functions such as relational or SQL type queries or database updates on the lower power machine accessing the database contents. Typically, the relations between records are static and are determined when the database is produced.

The database architecture is designed so that the database contains information specific to operations performed on the lower power machine and that data may be protected from transferring between machines (e.g., IR Beaming). The database architecture also provides password protection from accessing specific leaf node information. In addition, the database architecture is designed for lightweight implementation to use minimum system resources (computer power or memory) for running on low power machines. The databases formed by the present invention do not need to update the records on the handheld computer. Structured query mechanisms are not necessary on the low power computer.

The unique database architecture of the present invention, as will be described in conjunction with FIG. 1, incorporates various database fields which includes Node and End Node Record Fields, QAF (Question-Answer-Fact) Leaf Record Fields, Fact Leaf Record Fields, Bitmap Leaf Record Fields, and Root Record Fields. The various nodes are stored as records on the database and are defined by the fields. Each of the various database fields will be described in more detail below.

As seen in FIG. 1, the Root Node can link another Node (a link Node). The link Node can link to additional link Nodes or to an End Node. The End Node is linked to various content based fields including the QAF (Question-Answer-Fact) Leaf Nodes, Fact Leaf Nodes, and Bitmap Leaf Nodes. Also seen in FIG. 1 are Keys or an identification number (ID) at the end of each node which are unique numeric node identifiers which allow the application to locate the appropriate fields to access, retrieve, or store content.

The first or main record is the Root Record Field. The Root Record Field is used to provide the overall information about the database. Every database formed by the present invention has at least one root record as the first entry in the database. Examples of some of the data stored in the Root Record Field are: title (i.e. “Introduction to U.S. Government Leaders”); provider (i.e. U.S. Government Handbook); splash (i.e. “ibrite Introduction to the U.S. Government); and Bitmap Key (i.e. 1234). Below is a listing of the data fields within the Root Record Field.

Root Record Fields

| | |
|---|---|
| Key | Unique numeric node identifier |
| ParentKey | ID of the parent |
| RecordType | Root |
| DB Version | 16-bit data version number representation |
| FirstLeafKey | Key of the first leaf |
| Title Bitmap Key | (Not used) Key of the Bitmap to be displayed on the |
| | splash screen |
| Flags | 16 bit flag identifier (Described below in Table B) |
| NumLinks | Number of child keys associated with the root |
| Links | Null terminated concatenated string of child Keys |
| Title | Title of the Node (String) |
| Provider | (Not used) Name of the data provider |
| Comments | (Not used) Splash screen comments from the data |
| | provider (i.e., copyright, proprietary) |
| Icon name | (Not used) Label of the icon displayed on the Palm ™ |
| | Applications screen |
| Password | (Not used) Password string associated with password |
| | protected leaves |
| Splash | The title displayed on the splash screen (String) |

Another field type is the Node record type which provides the basic building block for hierarchical relations between the data. Nodes provide links to either other nodes or End Nodes. Organizing information into chapters, that are composed of sections, that are, in turn composed of paragraphs. The text is stored at the paragraph level. Thus, chapters and sections would be nodes and the paragraphs of text would be End Nodes. The End Node Record Type is the lowest level node in a hierarchical relation. End Nodes contain the relation between the parent node and various leaf nodes. Below is a listing of the data fields within the Node and End Node Record Fields.

Node and End Node Record Fields

| | |
|---|---|
| Key | Unique numeric node identifier |
| ParentKey | Key of the parent |
| RecordType | Node or End Node |
| NumLinks | Number of child keys associated with this node/end node |
| Flag | 16 bit flag for use by application to identify the node as |
| | valid. |
| Links | Null terminated concatenated string of child keys |
| Title | Title of the node (String) |

The Question-Answer-Fact (QAF), Fact, and Bitmap are all leaf fields which are used for storing the text and graphic data. The Question-Answer-Fact Leaf record type is used for storing the most detailed information and assessment method, for a specific topic. The information contains factual information as well as quiz information based upon a particular fact to assess the knowledge of the end user. An example of the information under a QAF would be a description of the Department of the Interior, along with the question “What organization does the Office of Fish, Game, and Wildlife report to?” Below is a listing of the data fields within the QAF leaf record field.

QAF (Question-Answer-Fact) Leaf Record Field

| | |
|---|---|
| Key | Unique numeric leaf identifier |
| ParentKey | Key of the parent |
| RecordType | QAF Leaf |
| LPI | “Page” number |
| Flags | 16 bit flag identifier (Described below in Table A) |
| Title | Title of the leaf |
| Question | Text of the question for this leaf |
| Answer | Text of the answer for this leaf |
| Fact | Text of the fact for this leaf |
| Difficulty | Relative difficulty of the QAF leaf on a scale of 1 to 5 |
| See Also Key | Key of a related leaf (max. of 3) |

The Fact Leaf Record Field is used for storing the most detailed information for a specific topic. The information contains factual information such as a description of the Department of the Interior. The Fact Leaf Record Field would not contain any questions. Below is a listing of the data fields within the Fact Leaf Record Field.

Fact Leaf Record Field

| | |
|---|---|
| Key | Unique numeric leaf identifier |
| ParentKey | Key of the parent |
| RecordType | Fact Leaf |
| Flags | 16 bit flag identifier (Described below in Table A) |
| See Also Key | Key of a related leaf (max. of 3). This is the link to the |
| | slide text and slide notes fields |
| Title | Title of the leaf (String) |
| Fact | Text of the fact for this leaf |

The Bitmap Leaf Record Field is used to store a graphic or illustration in digital form. In addition the Bitmap Leaf Record Field can have relational links from other leaf nodes which allow for illustrations to be tied to QAF or Fact leaves. An example of a Bitmap Leaf Record Field would be a digital illustration of the face of a US President. Below is a listing of the data fields within the Bitmap Leaf Record Field.

Bitmap Leaf Record Field

| | |
|---|---|
| Key | Unique numeric leaf identifier |
| ParentKey | Key of the parent |
| RecordType | Bitmap Leaf |
| Flags | 16 bit flag identifier (Described below in Table A) |
| See Also Key | Key of a related leaf (max. of 3). This is the link to the |
| | slide text and slide notes fields |
| Title | Title of the leaf (String) |
| Bitmap | Bitmap image for this record |

In addition to the database fields described above the present invention incorporates various flags and corresponding definitions. As seen above, each of the Root, Node and End Node, QAF, Fact, and Bitmap records contains Flags. Flags are defined settings or triggers which instruct the system of the present invention regarding access, protection, and other settings associated with each record. The Flags are used so the system can quickly determine if that particular record is password protected, copy able, or beam able depending upon the type of record. The system of the present invention includes bit definitions for a 16 bit leaf flag and database flags for the root record. The flag definitions provided below are examples of definitions the present invention may employ for defining the characteristics of a given record.

Bit Definitions for 16 bit Leaf Flag

0—Hidden: Used by the present invention to know if the user has chosen to hide that particular leaf or not. Currently, the present invention always sets this to zero.

1—Password: Used by the present invention to know if the leaf is password protected.

2—Seen: Used by the present invention to know if the leaf has been visited at least once.

3—Favorites: Set by the present invention whenever a user adds the leaf to their favorites list.

4—Highlight: Set and used by the present invention to know if a lead is highlighted by the content provider as a must see item.

5:7—Difficulty: Used by the present invention in Challenge mode for scoring.

8—Copy able: Used by the present invention to find out if it is OK to copy the fact field for that leaf.

9:15—Reserved for future needs of the present invention.

Database Flags for the Root Record

0—Challenge Enabled: Used by the present invention to find out whether or not to allow the challenge mode to be accessed. If 1, the Options menu will contain “Challenge” and if not, Challenge will not be available to the user.

1—Beam-able: If one, the Options menu will contain a “Beam present invention database” option allowing the user to beam the database if desired.

2—For an application of the present invention only. Copy enabled.

3—Structured: If the database is in the structured format, set this value to one. If it is unstructured, set this value to zero.

4—Beamed: Set and used by the present invention to determine whether or not the application was beamed to the current device.

5:6—Beam Time Demo Expiration: Used to define the number of days the user sets the timed demo to expire. If these values are zero, there is no expiration of the demo. If one, the demo expires in one day; two, the demo expires in fifteen days; three, the demo expires in thirty days.

7:10—reserved for future use.

11—Format: Set for format databases of the present invention. Always set to one.

12—Dictionary Format: Set for format databases of the present invention. Always set to one.

13—Bitmaps: Used by the present invention to find our whether or not the application contains bitmap leaves. This value should be set to one if the database contains bitmap leaves and zero if it does not. If the only bitmap in the database is the title bitmap, which is not included in the leaf section, this value should be set to zero.

14—Fact Only: Used by the present invention to find out if the database contains fact only leaves. The Slide text and Slide Notes are stored as Fact Only leaves. If neither of these is present, this bit will be zero.

15—QAF: Used by the present invention to find out if the database contains QAF leaves.

Database Structure—Generic Internal

Representation of a Record

In addition to the database fields and the flag definitions the database structure is also defined by the generic internal representation of a record. The following table and code helps to define the records within the database structure.

| Offset | Size | Description |
|---|---|---|
| 0 | 2 | FixedRegionSize |
| 2 | [FixedRegionSize] | Fixed binary block |
| [2 + | [Varies] | 1 or more concatenated, |
| FixedRegionSize] | | null-terminated strings |

************************************************************

* Type Declarations

************************************************************/

// data type macros
#define REC_KEY_TYPE UInt16
#define REC_LPI_TYPE UInt16
typedef enum {ROOT, NODE, ENDNODE,
QAFLEAF, BITMAP LEAF,
FACTONLYLEAF } NodeType;
typedef struct {

UInt16 challengeEnabled:1;
Uint16 beamEnabled:1
UInt16 copyEnabled:1
UInt16 structured:1;
UInt16 beamed:1;
UInt16 demoTime:2;
UInt16 reserved:4;
UInt16 powerViewerFormat:1;
UInt16 dictionaryFormat:1;
UInt16 bitmapLeaves:l;
UInt16 factOnly:1;
UInt16 QAFdb:1;

} DB_FLAGS_TYPE;
typedef struct {

REC_KEY_TYPE key;
UInt16 dbVersion;
DB_FLAGS_TYPE flags;
REC_KEY_TYPE firstLeafKey;
REC_KEY_TYPE titleBitmapKey;
UInt16 childKeyCount;
Char *childKeys;
Char *Title;
Char *Provider;
Char *Comments;
Char *Iconname;
Char *Password;
Char *Splash Title;

} rootFRStype;
typedef struct {

UInt16 reserved:8;
UInt16 valid:1;
UInt16 expanded:1;
UInt16 reserved:6;

} nodeFlagsType;
typedef struct {

REC_KEY_TYPE key;
REC_KEY_TYPE parentKey;
UInt16 childKeyCount;
UInt16 flag;
Char* childKeys;
Char* Title;

} innerNodeFRStype;
typedef struct {

REC_KEY_TYPE key;
REC_KEY_TYPE parentKey;
UInt16 childKeyCount;
UInt16 flag;
Char* childKeys;
Char* Title;

} endNodeFRStype;
typedef struct {

| UInt16 hidden:1; | // 1 = hidden |
|---|---|
| UInt16 pwdProtected:1; | // 1 = protected |
| UInt16 visited:1; | // 1 = visited at least once |
| UInt16 favorite:1; | // 1 = added to favorites list |
| UInt16 highlighted:1; | // 1 = hilighted |
| UInt16 difficulty:3; | // QAF difficulty |
| | (1 <= difficulty <= 5); |
| | Set to zero if fact |
| | only |
| UInt16 copyable:1; | |
| UInt16 reserved:7; | // initialize to zero |

} leafFlagsType;
typedef struct {

REC_KEY_TYPE key;
REC_KEY_TYPE parentKey;
REC_LPI_TYPE recLPI;
REC_KEY_TYPE
seeAlsoKey[MAX_SEEALSO_COUNT];
leafFlagsType flags;
Char* Title; // null terminate string.
Char* Question; // null terminated string
Char* Answer1; // null terminate all
strings even if it's empty.
Char* Answer2; // null terminate all
strings even if it's empty.
Char* Answer3; // null terminate all
strings even if it's empty.
Char* Answer4; // null terminate all
strings even if it's empty.
Char* Fact; // null terminate string

} leafFRStype;
typedef struct {

REC_KEY_TYPE parentKey;
REC_LPI_TYPE recLPI;
REC_KEY_TYPE
seeAlsoKey[MAX_SEEALSO_COUNT];
leafFlagsType flags;
Char* Title;
Char* Fact;

} factonlyFRStype;
typedef struct {

REC_KEY_TYPE parentKey;
REC_LPI_TYPE recLPI;
REC_KEY_TYPE
seeAlsoKey[MAX_SEEALSO_COUNT];
leafFlagsType flags;
char title[40];
BitmapType bitmapHeader;

} bitmapFRStype;

Through use of the database structure and fields defined above numerous software applications can be employed which allow for the storage and interaction of text and graphics files in a usable manner on handheld computer devices such as PDAs and smart phones. Two different software applications will be described below which utilize the unique database structure. In addition various other features and functions of the present invention will be described.

In a preferred embodiment, a software application utilizing the unique database structure of the present invention is employed which provides a text based training format, referred to as imaker™, which will be described in conjunction with FIGS. 2-29. The training format of imaker™ is particularly useful for capturing and storing maintenance procedures, operation manuals, reference materials, policy and company manuals, and test preparation materials. The application makes it possible to organize and translate any content which can be used for reference, study, training, or entertainment on a handheld computer. For illustrative purposes, a question and answer application discussing presidential facts will be discussed in conjunction with FIGS. 2-29.

FIG. 2 shows a handheld computer 201 with a screen 203 displaying the first page of a Fun Presidential Facts application created with imaker. The Navigation Bar 205 at the bottom of screen 203 makes it easy to move from page to page. You can also search for specific topics, names, dates, or other information by using the handheld computer search function 207.

FIG. 3 shows a screen capture 303 of the “Home” or Contents directory page of the Fun Presidential Facts application. In addition to displaying text, the present invention also allows for the use of a question and answer format as seen in screen capture 403 in FIG. 4. FIG. 5A represents a screen capture 503 of a correct answer screen and FIG. 5B represents a screen capture 504 of an incorrect answer screen. In either case, users can tap on the More Info button 505 to view the text associated with the question.

The user interface architecture is designed to present the user with the experience of drilling down for more detail, while traversing between topics in a unique mechanism. This user experience uniquely supports the discontinuous arrangement and display of contiguous information. Lower power machines (such as the PalmOS Handheld) only allow for display of information in a fragmented form in order to be displayed on the limited screen. This fragmentation causes discontinuous displays and interferes with the users comprehension of the material. The hierarchical arrangement of the database enforces a top-down organization, with the breath of the hierarchy reflecting the topics, and increasing depth, adding detail.

FIG. 6 shows a conceptual mapping of the user experience. Each of the squares represents one screen. When the user progresses through topics (horizontally across the figure), the material changes by subject. When a user progress through detail (vertically across the figure) the subject remains the same, but the information is more focused.

FIGS. 7-8B are examples of the application utilizing a Challenge Mode. FIG. 7 is a screen capture 701 of a Challenge Exam in which users attempt to answer a series of questions on a subject presented by the imaker application. FIG. 8A is a screen capture 801 of the Challenge Mode Results Screen which displays the results from the challenge exam. The Challenge Mode Results Screen also includes a detail bar 803 and an Accept Another Challenge button 805. In addition, FIG. 8B is a screen capture 807 displaying the details of the results of the challenge including correct answers for each category and total.

Creating a training application for use with the present invention is described in conjunction with FIGS. 9A-23. FIG. 9A is a screen capture 901 of the imaker application used for creating complex content. The pane 903 on the left displaying an “open book” icon labeled “New Application” 905 is where the user's organizational structure will appear. The book graphic shown is the “root” icon, that is, the starting place for all the sections and pages you will add to your application.

On the right of the screen 901 are various fields 907, 909, 911 for a user to fill in application information, enter text for your splash screen and contact screen, load bitmap images for your splash and contact screens, and set options for your application.

The screen 901 displays the organizational outline (or “tree”) of the application you are creating on the left in field 903 and the working area where you enter information and configure application components on the right in fields 907, 909, and 911. The user can also resize the tree window 903 horizontally by hovering the cursor over the right-hand border and then clicking and dragging to the right or left. The work area to the right of the tree window 903 on this user interface screen 901 for this application provides a place to enter information for the application. The application information includes a title field 911, text for the splash (initial) screen 907, and text for the contact screen 909. In addition, the user interface includes a place to load and test your splash screen/contact screen graphic in field 915, a place to set your application options with button 913 and a place to view statistics on the structure and size of your application in field 917. In addition, as the user clicks on different nodes within the application tree, the display to the right of the workspace changes to allow you to edit that specific component.

FIG. 9B is an illustration of the application organizational tree and the underlying database structure which shows the hierarchical section levels and the different page types. To select an item in this tree a user would simply click on its icon. Once an element is selected the user can use the keyboard Up and Down arrows to move through the list from one node to another. Navigation within the organization tree allows for moving an application tree element out of its “peer” group using the drag-and-drop function. The drag-and-drop function works by clicking on the node you want to move, drag it to its new position in the tree, and drop it. If the move you attempt is not allowed, the imaker application displays an error message box that explains the problem.

Referring back to FIG. 9A, when a user selects the Settings for Application bar 913 the user is provided the dialog box shown in FIG. 10 which is a screen capture 1001 for setting various options of the application. The screen capture 1001 provides users with the option of password protecting the application utilizing the Password Protection field 1003 and provides several options, such as the Beamable options in field 1005 and various other options using field 1007, for configuring how your program operates.

The password you set here applies globally whenever you enable password protection for an individual page. In other words, whenever you protect a FACT, QAF, or BITMAP page by checking the password option for that page, the password set here is the one the user must enter to view the protected screen on the handheld. Other settings include the Palm Challenge Mode Enabled which will let you try out the Challenge Exam testing mode after you install and open the application. The Mark New Pages as Copy-Enabled function automatically checks the Allow Fact Data To Be Copyable option on each FACT and QAF page created which allows the page information to be copied to other applications. The Structured Database option governs whether an application appears with section levels (structured) or as a simple page list (a “flat” or unstructured database) when it is exported. The Make Database Beamable option, when turned on, lets a user transfer the application and its database to a different handheld computer.

FIG. 11A is a screen capture which displays a Fact Entry Screen 1101. The Fact Entry screen 1101 includes a title field 1151 for each application as well as a difficulty field 1152 where the user can select a setting of from 1 to 5. The difficulty field 1152 sets the degree of difficulty of the question associated with the fact presented by the page and sets the question's point value for the Challenge Exam. For example, if the difficulty value is 5, a user getting this question right during a Challenge Exam would be awarded five points. The Fact Entry Screen 1101 also contains a Fact pane 1103 to enter the fact text for the page and a Q&A pane 1105, as seen in FIG. 11B, for entering a question specifically related to the text entered on the Fact pane 1103. The question will appear on the handheld computer when the application is in Q&A or Combo mode or when a user is taking a Challenge Exam.

In addition, screen capture 1101 includes a See Also field 1109 which allows the user to link one page to other pages. These associations usually denote a logical connection of some kind. For example, if one fact mentions a specific name in passing, a “See Also” link might display another page with more information about that person. Screen capture 1101 also has a Page Options field 1113 which has various options which include: Allow Fact Data to be Copyable which allows a user to copy a fact page from the imaker application to another handheld application, such as email or the memo pad; Highlight Page which “highlights” the page; Password Protect Page which password protects the page; and Re-edit Page which simply marks a page for attention (re-editing) by the next person who might work on the application. The Re-edit option does not affect the performance of nor show up in any way in the imaker application running on a handheld computer. The highlighted page, along with any other highlighted page, will be displayed exclusively when a user selects the Highlighted feature of imaker application. In other words, pages that have not been highlighted will not be displayed when the program is in this mode.

When the Q&A tab 1105, as seen in FIG. 11A, is selected the Q&A Entry Screen 1125, seen in FIG. 11B, is displayed. The Q&A Entry Screen 1125 contains blanks for entering the question 1120, the correct answer to the question 1121 and from one to three incorrect answers 1122, 1123, 1124. The incorrect answers should be misleading, that is, similar in nature to the correct answer so the right selection is not obvious. These answers appear when the imaker application is in Q&A or Combo mode or when a Challenge Exam is running. The answers are shown in a different, randomly selected order each time a user views a question.

In addition to the Fact tab 1103 and Q&A tab 1105 the user interface, as seen on the Fact Entry Screen 1101, also contains a bitmap tab 1107 for attaching bitmap images. Bitmap images are illustrations which can be presented to the user to show any graphic information. FIG. 11C is a screen capture of the Bitmap Entry Screen 1127 where bitmaps can be attached and stored using a format which allows for data compression in order to conserve limited resources on the low power computer. The bitmaps are uncompressed and mapped to the display as part of the database functioning.

FIG. 12, represents a screen capture 1201 of a Complex Content Validation Screen which is used to correct an error. By selecting the Go To button 1203 the imaker application displays the incorrect page and places the cursor in the field where the error occurred. The user can then correct the error, press F2 to redisplay the Validation screen 1201, and then click the Revalidate button 1205. If the page is now correct, its icon will turn from red back to white and the Validation screen 1201 will be cleared of the error.

FIGS. 13-23 are various user interface screen captures depicting numerous features and functions of the illustrative example described herein. The features and functions are representative of the various features and functions which can be employed with a software application using the present invention.

FIG. 13 depicts a toolbar which gives a user easy access to the functions common to creating and editing content application. FIG. 14 is a File Menu Options screen with numerous file options. The file menu options include: New (Ctrl+N) which creates a new application; Open (Ctrl+O) which opens a dialog box where you can select an existing imaker (.tdb) application to launch and edit; Close which closes the active application window; Save (Ctrl+S) which saves the application; Save As which saves a new application for the first time or saves an existing application under a different file name; Print which opens a Facts to Print dialog box; Validate (Ctrl+F1) which checks the imaker application for errors; Import (Ctrl+I) which opens an Import dialog box for importing an existing imaker application into imaker; Import Unstructured which opens an “Open Import File” dialog box for importing an unstructured (text file) database into imaker; Export to Palm Format (Ctrl+E) which opens an “Export” dialog box for exporting your application into Palm format for the handheld; Lock (Ctrl+L) which locks the current imaker application so that anyone opening the file after it is saved and closed will not be able to edit any password-protected page; and Unlock (Ctrl+U) which unlocks the protection described above for Lock. When a user selects Unlock, the imaker application will prompt the user for a password before unlocking the application.

Selecting the Save as file option opens the Save As dialog box which allows the user to browse the directory for where they want to save the application (or create a new one), enter the new file name in the blank next to “File Name,” and click Save to save the application. Selecting the Print file option opens the print dialog box, as seen in FIG. 15, which allows a user to select all FACT pages for printing. The user can deselect (uncheck) FACT pages they do not want printed and they can also click Deselect All to clear all the check boxes and then select the fact or facts they want to print by clicking the check box next to the fact title. Once the user selects OK the print job is sent to the printer. Print all facts by clicking Select All and then OK. Selecting the Print to File option prints the application fact information to a Rich Text Format file (.rtf) saved to a directory designated by the user.

Under the Validate file option if there are problems with any of the pages, the application tree icon of the page in error will turn from white to red and the “Validation Window” will open, displaying the type and location of the problems.

When a user selects a protected page in a locked file, a blank workspace with an “unlock” message appears to the right of the application tree instead of the normal information fields. Locking an application also disables the Password Protection option in the “Settings for Palm Application” dialog box. In other words, it prevents a user from entering a new password for the application. This function also “hides” password-protected pages so they do not appear in (and don't print from) the “Facts to Print” dialog box. The Lock and Unlock functions are not active unless the user has set a password for the application.

FIG. 16 displays the Edit Menu Options in the imaker application on a personal computer. The Edit Menu 1601 provides standard editing functions that apply to the information workspace on the right of the user interface seen in FIG. 9A. The Edit Menu 1601 Options include: Undo Text (Ctrl+Z) which reverses the last text action (for example, cut, paste, copy, and delete) in FACT and Q&A text fields; Cut (Ctrl+X) which cuts selected text in an information field to the clipboard (for example, from the Fact pane on the page workspace); Copy (Ctrl+C) which copies selected text to the clipboard from an imaker workspace information field; Paste (Ctrl+V) which pastes text from the clipboard into the selected workspace information field; Delete which deletes selected text from a workspace information field (Pressing the Delete key also performs this function.); Select All which selects all text in the active information field; Format Font which opens a font format dialog box that lets you add bold emphasis and/or underline and change the size of text selected in a Fact pane; and Import from Text File which opens an “Open Import File” dialog box for importing a text file directly into the Fact pane of a FACT or QAF page.

FIG. 17 depicts the View Options Menu in imaker application on a personal computer. The View Menu 1701 controls some of the elements that appear or are hidden on the workspace when the program is open. The first two choices are “toggle” options. In other words, a user can turn them on and off by clicking them. Checked means on or visible and unchecked means off or hidden. The View Menu 1701 includes the following options: Toolbar which may display or hide the imaker toolbar seen in FIG. 13; Status Bar which may display or hide the date, time and application activity (such as program loading progress) at the bottom of the workspace screen, on (visible) and off (hidden); Go to Validation Window (F2) which opens (or brings to the front if the window is already open) the Validation Window seen in FIG. 12; and the Application Options which opens the “Application Options” dialog box shown in FIG. 18.

The Application Options dialog box 1801 includes a Limit Validation Error List 1803 which limits the number of errors displayed when an imaker application file is validated. The Application Options dialog box 1801 also includes an Import Unstructured field 1805 which controls how imported text will be split into pages. To set these parameters, open the “Import Unstructured Options” dialog box 1901, seen in FIG. 19, by clicking the Settings button 1806. The setting chosen in the Import Unstructured Options dialog box 1901, in FIG. 19, would create a new page for each paragraph in a source document where paragraphs are separated by one carriage return.

FIG. 20 displays the Node Menu 2001 in the imaker application on a personal computer. The nodes are the “tree” elements you create as you construct your application as previously discussed in conjunction with FIG. 9B. These nodes include major categories, sub categories, major topics, sub topics, and pages. The Node Menu 2001 provides options for creating, renaming, deleting, and rearranging these elements. It also provides functions for expanding and collapsing the contents under each element in the tree display and options for moving directly to parent and root elements. To display this menu, a user can either click Node on the menu bar to show the drop-down version or right-click on any icon in the application tree to display a popup version. The Node Menu 2001, like other imaker menus, grays out elements whenever they are not available for use. In addition, it lists different options depending on what elements a user has selected in the application tree. The Node Menu 2001 is displayed when a user has just created a new application but has not added any section or page elements.

The Node Menu 2001 includes the following options: Undo which is a context sensitive menu option which may undo the most recent reversible node action; Add Major Category (or Sub Category or Major Topic or Sub Topic) which adds a new section at the designated level to your organization tree; Add Page which opens a “fly out” menu [see FIG. 21] with three options for adding a new page to your application under the section node you've selected; Delete Section (or Page) which deletes a selected element or elements (section or page) from the application tree; Rename Section (or Page) which allows a user to edit the name of a selected section or page element; Cut Section (or Page) which cuts the selected section or page element and places it in the node clipboard; Copy Section (or Page) which copies the selected section or page element and places it in the node clipboard; Paste at Section (or Page) which pastes the contents of the node clipboard as a subordinate element(s) to the selected node in the tree; Clear Node Clipboard which clears the contents of the node clipboard; Move Up which moves a section or page element up one place; Move Down which moves a section or page element down one place; Move First which moves a section or page element to the top of a list of section or page elements at the same level; Move Last which moves a section or page element to the bottom of a list of section or page elements at the same level; Indent which demotes a section one level by creating a blank Major Category, Sub Category, or Major Topic above it; Indent All Children which is identical to Indent except it acts on all sections and pages below the selected section (“Children” are subordinate node elements); Collapse which collapses (hides) all the subordinate elements of a major category, sub category, major topic, or sub topic section; Expand which expands (shows) all the subordinate elements of a major category, sub category, major topic, or sub topic; Go to Parent which changes the selected element of the tree from a subordinate page or section to its “parent,” that is, to the element directly above it in the tree's hierarchy; Go to Root which changes the selected element in the tree to the application's root element; Convert Page which changes the page type (QAF, FACT or BITMAP) for a selected page; Convert All Pages which is identical to Convert Page, except it acts on all pages; Mark All Pages Copy-Enabled which allows the text in Fact panes to be copied to other applications on a handheld; and Remove Copy-Enable From All Pages which disables the ability to copy Fact panes to other applications on a handheld.

The Add Page option listed and described above has three options for adding a new page to the application which are seen in FIG. 21. The three options for adding a new page are add QAF (Ctrl+Q) which adds a QAF page, add FACT (Ctrl+F) which adds a FACT page, and add BITMAP (Ctrl+B) which adds a BITMAP page.

FIG. 22 displays the Windows viewing options as seen in Windows Menu 2201 in the imaker application on a personal computer and provides the standard Windows options for viewing multiple windows in an application. FIG. 23 displays the Help Menu Options 2301 in the imaker application which displays the Help for imaker option and the About imaker menu choice. The Help for imaker opens the imaker Online Help, the Register provides information on how to register imaker if the software is still in Demo mode; the Enter Serial Number function opens a dialog box to complete product registration and take imaker out of Demo mode; and the About feature displays the imaker version and copyright information.

FIGS. 9A-23 and the associated description relate to the creation and editing of the text and graphic content for a content application such as a question and answer exam guide or the like. FIGS. 9A-23 represent the various user interface screens in which the user can add facts, text, and graphics in a usable form. The user interface screens are all associated with a software application which is installed and run on a personal computer or which may be run over a network, an internet connection, or some other electronic communication connection not specifically described. When the user has entered the textual and graphic or image content the data is then converted, sorted, stored, compressed and manipulated into the unique database structure previously described. Once the textual and image data is converted and compressed the data can be loaded onto a handheld computer or PDA type device.

The handheld computer or PDA which now contains the converted and compressed data can then be used to access, in a user friendly manner and format, as previously described in conjunction with FIGS. 2-8. Therefore, the present invention provides a user with the ability to input text and image content for numerous purposes which can later be viewed using a handheld computer device. The unique database structure of the present invention also allows for and includes various other features and functions which will now be discussed in conjunction with FIGS. 24-39.

One of the unique and novel features of the present invention is the color conversion mechanism. The color conversion mechanism is able to take color graphics or images which are included as part of the content added and convert the images into black and white, gray scale, or color images which can then be displayed on handheld computers and PDAs. Therefore, a color image can still be displayed on non-color PDA displays by converting the image to a gray scale image. The present invention accomplishes this feet utilizing a color table modification algorithm.

Step one of the algorithm is to create color lookup tables to map from stored image pixel values to values which may be stored bitmap images for multiple pixel depths. Pixel depth is the number of bits used to store a single pixel. As will be described in conjunction with FIG. 24, the present invention, converts the color look-up tables through various steps.

In step 2401 the function of converting the color look-up tables is initiated and converts a color bitmap to a monochrome or gray scale. At step 2402 a determination is made as to whether the handheld computer display is intended as a two color display which allows only supports a two color image. Provided the display is for a two color image (Black and White), the present invention defines the first half of the color table as Black (represented as value 0 (hexadecimal: %H00)) and the last half of the color table as white, represented by 255 (hexadecimal: &HFF).

Once the modified table is established the image is scanned by rows in step 2404. For conversion of a color image into a two color image (pixel depth of 1), the present invention creates a bit array of the image based on an intensity threshold. Once the colors are mapped the present invention creates an output Bitmap array by placing the corresponding pixel color into the appropriate array location. After creating the bitmap array the present invention stores the bitmap array in step 2408 and then exits the algorithm at step 2409.

In the event that the display supports more than a two color image the determination is made, in step 2405, as to whether the display supports a four color image. Provided the display supports a four color image the present invention, in step 2406, defines the modified color look-up table into quarters having pixel values set at Black, Dark gray (represented as value 85 (hexadecimal: &H55)), Light gray (represented as value 170 (hexadecimal: &HAA)), and White.

After creating the modified four color look-up table, the image is scanned by rows in step 2407. For a converting a color image into a four color image (pixel depth of 4), the present invention maps predefined colors into the exact match. The predefined colors are: White, Yellow, Magenta, Red, Cyan, Green Blue, and Black. All other colors are mapped into the appropriate color by computing the average RGB (Red Green Blue) pixel color, scaled by some factor between 0 and the maximum color intensity value, preferably 85. Once the colors are mapped the present invention creates an output Bitmap array by placing the corresponding pixel color into the appropriate array location. After creating the bitmap array the present invention stored the bitmap array in step 2408 and then exits the algorithm at step 2409.

In the event that the system, at step 2405, determines the image is not intended for a display which supports only a four color image the present invention exits the routine.

Color Step Down

Another feature of the present invention is the color image step down mechanism which uses an iterative algorithm to produce the largest image reflecting the content of the image that will fit effectively on a color display of a handheld computer device.

As will be described in conjunction with FIG. 25, the present invention processes and compresses the images in a variety of steps. In step 2501, the present invention begins the color image step down process. The present invention sets the product bit map size to maximum, in step 2502. Next, step 2503, the COM interface is used to produce a graphic output image of the current slide in a standard format, at the current product bitmap size. At step 2504, the present inventions reads in the graphic output file and then, step 2505, computes the modified look-up table. Next, at step 2506, the system performs RLE (Run Length Encoding) compression on the image while converting the image with the modified color look-up table.

Once the image is compressed the present invention determines, at step 2507, if the resulting compressed image size is less than the threshold for the handheld computer display. If the resulting compressed image file is less than the handheld computer display threshold the present invention determines if the product bitmap size is set to average, step 2508. In the event that the bit map size is not set to average the bit map size is set to average at step 2509. In the event that the bit map size is set to average the product bit map size is set to the smallest setting in step 2510. After the bit map size is set to a different size in either step 2509 or 2510 the image is reprocessed through steps 2503 through 2507.

Once the present invention determines that the resulting compressed image is less than the handheld computer display threshold, as determined in step 2507, the compressed image file is stored in step 2511. The system determines if additional images need compression in step 2512. In the event that more images need compression the next images is processed through the color image step down algorithm starting at step 2502. In the event that the system determines there are no additional image files which need compression at step 2512, the color step down algorithm process is terminated at step 2513. The stored compressed images files are then ready to be transferred to a handheld computer device.

Gray Scale Step Down

Another feature of the present invention is the gray scale image step down mechanism which uses an iterative algorithm to produce the largest image reflecting the content of the Microsoft PowerPoint slide that will fit effectively on a non-color or monochrome display of a PDA device. The Gray Scale Step Down algorithm can at least be run on the Windows platform.

As will be described in conjunction with FIG. 26, the present invention processes and compresses the images in a variety of steps. In step 2601, the present invention begins the gray scale image step down process. The present invention sets the product bit map size to maximum, in step 2602. Next, at step 2603, the COM interface is used to produce a gray scale graphic output image of the current slide in a standard format, at the current product bitmap size.

At step 2604, the present invention reads in the graphic output file and then, step 2605, computes the modified gray scale look-up table. In step 2605, the produced bit map images use gray scale encoding to four levels of quantization (two-bit values). The Color Look-Up Table Modification Algorithm described above will also work to produce maps for this limited grayscale.

Next, at step 2606, the system performs RLE compression on the image while converting the image with the modified gray scale color look-up table. In step 2606, the image conversion is done by closest match of an array of basis colors to the color of the pixels, as opposed to intensity thresholding, or color clustering.

Once the image is compressed the present invention determines, at step 2607, if the resulting compressed image size is less than the threshold for the handheld computer display. If the resulting compressed image file is less than the handheld computer display threshold the present invention determines if the product bitmap size is set to average, step 2608. In the event that the bit map size is not set to average the bit map size is set to average at step 2609. In the event that the bit map size is set to average the product bit map size is set to the smallest setting in step 2610. After the bit map size is set to a different size in either step 2609 or 2610 the image is reprocessed through steps 2603 through 2607.

Once the present invention determines that the resulting compressed image is less than the handheld computer display threshold, as determined in step 2607, the compressed image file is stored in step 2611. The system determines if additional images need compression in step 2612. In the event that more images need compression the next images is processed through the color image step down algorithm starting at step 2602. In the event that the system determines there are no additional image files which need compression at step 2612, the gray scale step down algorithm process is terminated at step 2613. The stored compressed files are then ready to be transferred to the handheld computer.

Zoom Methodology

Another feature of the present invention is the zoom feature which provides the user the ability to zoom in and out of the text and images. The user interface for the zoom methodology consists of two parts: images and text.

The zoom methodology relates to the handheld computer side of the step-down methodology. The present invention, using the step down technology previously discussed prepares the images and text that zoom later presents.

The zoom methodology will be discussed in conjunction with FIGS. 27-29. The initial display of an image consists of a thumbnail graphic, which fills the entire screen of the handheld computer device (see FIG. 27). For example, on the Palm series of computers, the image display is 160 pixels by 120 pixels. When the user taps the pointer on any area in the thumbnail image a new, larger version of the thumbnail image is displayed, as shown in FIG. 28.

The display process attempts to center the portion of the image corresponding to the point where the user touched the display screen with the pointer on the thumbnail image. However, the display is constrained by the edges of the larger image in that the larger image will not be panned to show any area beyond the edge of the display, as illustrated in FIG. 29. As seen in FIG. 29, the user is able to zoom the thumbnail slide seen in FIG. 27 to a level at which the image or parts of the image are more easily readable.

For image displays, when the user selects an operation that changes the size of the image display a rendition of the slide image is extracted from the database into an image buffer. The image buffer contains the entire scope of the graphic being displayed.

Next a clipping region is set to map a portion of the image buffer to the PDA display. The clipping region is constrained such that it will not extend past the boundaries of the buffer or screen. An initial displacement for the image is determined. The initial displacement is a function of the fractional offset the tap position is (horizontally and vertically) from the edge of the thumbnail display, and scaled by the ratio of the thumbnail size to the larger image size. In addition, the initial displacement is stored for further operations (e.g., scrolling) and then the image is displayed.

Another unique feature of the present invention is the ability to scroll, or pan, the image on the handheld computer display. The image scrolling mechanism uses an algorithm which works on the handheld computer to provide visualization into a portion of a large image.

When a larger image is displayed several control options are available. First, if the user taps on the image, the display reverts to the thumbnail image. The user may also place the tip of the stylus or pointer on the screen and drag the stylus in some direction. As the user drags the stylus the larger image is linearly panned in the opposite direction, giving the appearance of the display moving in the direction of the drag. The dragging operation is blocked from taking the edge of the image beyond the border of the display.

Multiple drags can be performed to pan the image further than the physical size of the screen. The effect of the dragging operations is cumulative in that the total pan is the sum of the individual dragging operations.

The scrolling presentation is continuously updated, giving a smooth transition reflecting the rate at which the user drags the stylus across the screen.

For image displays, when the user selects an operation that changes the region of the image displayed, initially a rendition of the slide image is extracted from the database into an image buffer. The image buffer contains the entire scope of the graphic being displayed. A clipping region is set to map a portion of the image buffer to the handheld computer display, and the image buffer is drawn. The clipping region is constrained such that it will not extend past the boundaries of the buffer or screen.

Initially, the image buffer is drawn to center on the point that the user tapped with the stylus. The present invention performs the following process during the drag operation. First, the present invention records the initial tap location on the screen and the initial displacement. Next, when a stylus move is detected, the sum of the displacement from the initial tap location and the initial displacement is determined. The amount of displacement is constrained to the edge of the image buffer. The present invention determines if the displacement has changed and if so the image is redrawn with the displacement from the stylus move.

FIGS. 30-41 are illustrative of an additional embodiment of another content based application entitled “termMaker” which utilizes the unique database structure of the present invention to provide converted and compressed data for a handheld computer which contains both text and image content. The termMaker application is described in more detail below and is intended as an illustrative example of applications which can be derived utilizing the unique database structure described herein and is not meant to limit the scope of the present invention.

The termMaker application is a software application entered through a PC based application with a user interface which converts and condenses large amounts of text and graphics data into a format which can be loaded onto and used by a handheld computer. The termMaker application is specifically related to dictionary or encyclopedia based content showing content alphabetically.

FIG. 30 represents a screen capture 3001 of the main termMaker user interface. The user interface has four major elements: 1) the application window 3003 on the left that displays the “books” that organize terms alphabetically, 2) the workspace 3005 where users set application properties and enter and edit dictionary terms, 3) the toolbar 3007, 4) the termMaker menus 3009, and the termMaker Information field 3011. In the termMaker application the book “tree” 3004 of the dictionary is fixed, in other words, a user cannot add, delete, or edit books in the application window under “New Dictionary.” A user can, however, add, delete, and edit the terms listed in each book. Users can also resize the application window horizontally by hovering your cursor over the right-hand border and then clicking and dragging to the right or left. The workspace 3005 to the right of the application window 3003 provides: a place to enter identifying information for the termReader dictionary, including the dictionary title, text for the dictionary splash (initial) screen, and text for the dictionary contact screen; a place to load and test your splash screen/contact screen graphic; a place to set your dictionary application options; and a place to enter or edit dictionary terms when a book other than the main title at the top of the application window is selected.

FIG. 31 is an illustration of a sample application window with terms displayed. The application window allows users to view the contents of the dictionary and select a term for editing quickly and easily. FIG. 31 displays a sample application with the “A” book open and some terms displayed. Selection of any of the displayed terms will open that term in the workspace 3005, as seen in FIG. 30, to allow users to view and/or edit that specific component. FIG. 32, is a screen capture 3201 of the user interface when a term is selected. The interface contains a definition tab 3203 which contains the text related to a specific term or definition and a bitmap tab 3205 which allows users to attach images related to or corresponding to that particular definition.

When a user wishes to add a new term within the application window, the user can right-click in the window's white space and select Add Term from the pop-up menu 3301 seen in FIG. 33.

To create a new dictionary, the user can launch the termMaker application which will provide the user interface 3001 seen in FIG. 30. By inputting data into the termMaker Information field 3011, which is shown in FIG. 34, the user can create a new dictionary or review an already existing dictionary by inputting the name of the dictionary into field 3012. Dictionary field 3012 allows a user to enter a title for a specific termMaker dictionary and the label next to the application window 3003, seen in FIG. 30, the “root” icon shown on the left will change to the new title. The title entered will be displayed on the termReader splash and contact screens on a handheld computer. The Palm Creator ID field 3013 is an identifying “mark” to protect your application from being overwritten if a another application with the same application label is installed on your handheld computer. Creator ID protection only works when the Creator ID is different, that is, the program with the identical name comes from another source. In other words, if the user creates another program with the same name and installs it, the earlier program will be overwritten because they have the same Creator ID. The Label on Palm field 3014 allows a user to enter a one-word label for the application icon. The application icon name will appear below the program icon on the handheld's “Application Picker” screen. Generally this should be eight characters or less.

In addition the user can change the settings for the dictionary by selecting the Settings for Dictionary bar 3015. When the user selects the Settings for Dictionary bar 3015 the user is provided a Settings for Dictionary dialog box 3501, as seen in FIG. 35. Any password set here, using the Password Protection field 3503, applies globally whenever a user enables the password protection for an individual term. In other words, whenever a user protects a term by checking its password option, the password set here is the one the user must enter to view the protected definition on the handheld. If the user does not set a password in the “Settings for Dictionary” dialog box 3501 and later attempts to check the password-protect option for an individual term, termMaker will prompt you to create one.

The two other options available in this dialog box are Mark New Terms as Copy-Enabled 3505 which when checked functions to automatically check the Allow Definition To Be Copyable option on any new terms created which allows the definition to be copied from the dictionary to another application on a handheld computer, and the Make Database Beamable 3507 which when turned on, lets a user beam the dictionary application and its database to a different handheld computer. The user can set the “beamed copy” of the dictionary to act as a time-limited demo, active for 1, 15, or 30 days, or can be set to an unlimited time (no timelimit).

As previously described in conjunction with FIG. 32, the user interface contains a definition tab 3203 and a bitmap tab 3205. FIG. 36 is a screen capture 3601 of the “Term Data” Workspace with Definition Tab 3603 selected. The user can now manually enter a definition for the term in the “Definition” space 3604. The user can also cut and paste text from another application, or you can use the Import from Text File option on the Edit Menu to insert text. The Term Data workspace 3601 also lets the user select “See Also” 3607 terms for cross-reference and has three options for configuring the term's behavior and appearance on a handheld computer. The “See Also” function 3607 is a cross-referencing tool that allows users to link one term to other terms. Display each “See Also” drop list by clicking the arrow next to it and select one of the displayed terms to create a link.

In addition, the user can set various term options which include: Allow Definition to be Copyable which allows a user to copy a definition into another application; Password Protect Term which allows users to protect a term's content with a password; and Re-edit Term which simply marks a term for attention (re-editing) by the next person who might work on the application in termMaker.

Also seen in FIG. 36 is the Bitmap tab 3605 which allows the user to attach an image or graphics file. The “Bitmap” Tab on Term Data Workspace is shown in FIG. 37. A user can add a Bitmap to a Term using both color and/or black and white bitmaps. To add a bitmap to a term, click the Bitmap tab 3605 in the Term Data workspace 3601, to bring the bitmap window 3701 forward, then set the bitmap settings. Bitmaps should be at least 160 pixels wide by 120 pixels high, and may be 256 color bmp files.

Another feature of the termMaker application is the ability to validate the application for errors. As seen in FIG. 30, the toolbar 3007 contains various toolbar buttons. One of the termMaker toolbar buttons is the Validate button. When the Validate toolbar button is selected a Validation Errors dialog box 3801 appears, as seen in FIG. 38. The Validation Errors dialog box 3801 allows a user to check an application for errors. In the event that the dictionary contains no errors, a message box appears stating that fact. In the event that errors do exist, the icons for terms that need to be corrected turn red in the application window 3003, as seen in FIG. 30. If the termMaker application detects errors, it also automatically opens the Validation Errors Window 3801, which shows the location and the nature of the problems in the Validation Window 3803. To correct an error, select the error in the Validation Window 3803 and click the Go To button 3805. The termMaker application displays the incorrect term and places the cursor in the field where the error occurred (or the first field with an error if there are more than one). Correct the problem and then press F2 to redisplay the Validation Window 3803. Correct the next error and repeat this process until all errors have been fixed and then recheck your application by clicking the Revalidate button 3807. When the last problem has been corrected, clicking the Revalidate button 3807 will display an “Application Is Valid” message. Click the Close button 3809 to close the message box and return to the application screen.

To run the termMaker or dictionary application on a handheld computer, such as a Palm personal digital assistant, the user would tap the termMaker application icon, referred to as termReader on a handheld computer to open the dictionary. When the termReader application is opened the splash screen icon and text will display briefly and then an “alphabet” screen 3901 like the one shown in FIG. 39 will appear. The user can then tap on any of the letters on the alphabet screen 3901 to display the terms beginning with that letter, as seen in FIG. 40. FIG. 40 illustrates a handheld computer screen capture 4001 of the terms listed alphabetically when the letter “A” was selected in the manner described above. If no terms are listed under the letter tapped, termReader displays a “Select Again” message box. The user can also search for a term by entering it in the “Look Up” field 4003. The termReader application automatically displays the closest match of the letters entered. If no term matches the search word, termReader stops accepting letters after the closest match. (For example, if one were searching for “bidding” in the screen above, the “Look Up” field would stop accepting letters after “bid.”)

FIG. 41 displays a handheld computer screen capture 4101 of the termReader application with a Definition Selected. As seen in FIG. 41, the user is given the text based content behind a term and can also access attached image files by selecting the image icon 4103. The user can navigate using the toolbar 4105 at the bottom of the termReader screen 4101 by tapping on the desired icon or button. The various buttons include a letter category field 4107 which indicates the letter category (“book”) you are currently in and tapping this button displays the alphabet screen, the Also field 4109 displays a list of “See Also” terms, the term navigation field 4111 allows the user to move throughout the terms, and the definition navigation field 4113 allows the user to move throughout the definition. The user can also tap the handheld computer's menu icon at any time to display termReader's Options or Info menus. From the Options Menu, the user can change the display font size, change the termReader startup preferences, add definitions to a “Favorites” list, or view your “Favorites” list.

The imaker and termMaker software applications are merely example embodiments used to illustrate the types of software applications which can be employed utilizing the unique database structure of the present invention.

While the preferred embodiment and various alternative embodiments of the invention have been disclosed and described in detail herein, it will be apparent to those skilled in the art that various changes in form and detail may be made therein without departing from the spirit and scope thereof.

We claim:

1. A database architecture for handheld computer devices comprising:
a root node for providing information about a database;
a plurality of leaf nodes for storing a plurality of content;
at least one link node for linking said root node to at least one end node or to another of said at least one link node;
wherein said end node connects to at least one of said plurality of leaf nodes.

2. The database architecture of claim 1, wherein said root node, said plurality of leaf nodes, said at least one link node, and said at least one end node are stored as records within said database.

3. The database architecture of claim 1, wherein said plurality of leaf nodes comprises at least one Question-Answer-Fact (QAF) leaf node.

4. The database architecture of claim 1, wherein said plurality of leaf nodes comprises at least one Fact leaf node.

5. The database architecture of claim 1, wherein said plurality of leaf nodes comprises at least one Bitmap leaf node.

6. The database architecture of claim 1, wherein said plurality of content comprises text content.

7. The database architecture of claim 1, wherein said plurality of content comprises image content.

8. The database architecture of claim 1, wherein said plurality of content contains reference material.

9. The database architecture of claim 1, wherein said plurality of content contains training material.

10. The database architecture of claim 1, wherein said plurality of content contains testing material.

11. A database architecture system for creating content for viewing on handheld computing devices comprising:
a database architecture comprising:
a root node for providing information about a database;
a plurality of leaf nodes for storing a plurality of content;
at least one link node for linking said root node to at least one end node or to another of said at least one link node;
wherein said end node connects to at least one of said plurality of leaf nodes;
a first software program for entering and editing said plurality of content within said database architecture; and
a second software program for viewing said plurality of content on a handheld computing device.

12. The database architecture system of claim 11 wherein said first software program is run on a personal computer.

13. The database architecture system of claim 11 wherein said second software program is run on said handheld computer device.

14. The database architecture system of claim 11 wherein said plurality of content comprises text content.

15. The database architecture system of claim 11 wherein said plurality of content comprises image content.

16. The database architecture system of claim 11 wherein said plurality of content contains reference material.

17. The database architecture system of claim 11 wherein said plurality of content contains training material.

18. The database architecture system of claim 11 wherein said plurality of content contains testing material.

19. A method of providing content on a handheld computing device comprising the steps of:
entering a plurality of content through a first program into a database; said database having a database architecture comprising:
a root node for providing information about a database;
a plurality of leaf nodes for storing said plurality of content;
at least one link node for linking said root node to at least one end node or to another of said at least one link node;
wherein said end node connects to at least one of said plurality of leaf nodes;
processing said content to said handheld computing device; and
viewing said content through a second program run on said handheld computing device.

20. The method of claim 19 further comprising the step of:
compressing said content to fit on a display of said handheld computing device.

21. The method of claim 19 wherein said processing further comprises the steps of:
determining the type of said handheld computing device; and
converting said content to meet the determined type of said handheld computing device.

22. The method of claim 21, further comprising the steps of:
determining the type of said content, wherein said content comprises text content and image content; and
converting said image content to a color scheme of said handheld computing device.
